(19) United States
(12) Patent Application Publication
(10) Pub. No.: US 2008/0260331 A1
(43) Pub. Date: Oct. 23, 2008

(54) Multiplexer/Demultiplexer, Method for Fabricating the Same, and Optical Multiplexe/Demultiplexer Module

(75) Inventors: Homare Takeda, Kyoto (JP); Koichi Furusawa, Kyoto (JP); Junichi Kumasako, Kyoto (JP); Xiangquan Zhang, Shiga-ken (JP)

Correspondence Address: OSHA LIANG L.L.P., 1221 MCKINNEY STREET, SUITE 2800, HOUSTON, TX, 77010, US

(73) Assignee: OMRON Corporation, Kyoto-shi (JP)

(21) Appl. No.: 11/883,256

(22) PCT Filed: Jan. 20, 2006
(86) PCT No.: PCT/JP06/00832

§ 371 Date: Jul. 27, 2007

(30) Foreign Application Priority Data
Jan. 27, 2005 (JP) 2005-020216

(51) Int. Cl. G02B 6/32

(52) U.S. Cl. 385/33

(57) ABSTRACT

A lens 39 is molded in one of the surfaces of a support plate 33, and a lens is molded in one of the surfaces of a support plate 35. The support plate 33 is integrated with the support plate 35 with a filter 34 sandwiched between the other surfaces of the support plates 33 and 35. In the support plates 33 and 35, seal portions 38 and 40 are formed to have a height larger than a lens thickness, so as to surround lenses 39 and 41. A spacer 31 is bonded to the seal portion 38 of the support plate 33 with an adhesive agent, and a spacer 37 is bonded to the seal portion 40 of the support plate 35 with an adhesive agent. To both end faces of the optical multiplexer/demultiplexer 301 thus formed, fiber arrays 42 and 43 are coupled respectively to form an optical multiplexing/demultiplexing module 401.

### TECHNICAL FIELD

The present invention relates to optical multiplexers/demultiplexers which can take out, by demultiplexing an optical signal including light having a plurality of wavelengths, an optical signal having each wavelength or produce an optical signal including light having a plurality of wavelengths by multiplexing the light having the plurality of wavelengths. The present invention also relates to optical multiplexing/demultiplexing modules in which the optical multiplexers/demultiplexers are used.

### BACKGROUND ART

FIG. 1 is a cross sectional view showing a structure of a conventional optical multiplexing/demultiplexing module disclosed in Japanese Patent Application Laid-Open No. 10-268157 (Patent Document 1). In the optical multiplexing/demultiplexing module 201, an optical unit 15 is formed by sandwiching a lens holder 12, which holds an aspherical lens 14, between spacers 11 and 13, and an optical unit 20 is formed by sandwiching a lens holder 17, which holds an aspherical lens 19, between spacers 16 and 18. The optical unit 15 and the optical unit 20 are accommodated in a cylindrical body 22 with a filter 21 sandwiched therebetween. A light emitting portion 24 having a light emitting element 23 is attached to an end face of the spacer 18, and a fiber array 27 including an input optical fiber 25 and an output optical fiber 26 is coupled to the end face of the spacer 11 to form the optical multiplexing/demultiplexing module 201.

As shown in FIG. 1, an optical signal having a wavelength λ1 inputted from the input optical fiber 25 is reflected with the filter 21 while an optical signal having a wavelength λ2 outputted from the light emitting element 23 is transmitted through the filter 21, and the optical signal having the wavelength λ1 and the optical signal having the wavelength λ2 are superposed and outputted from the output optical fiber 26.

In the optical multiplexing/demultiplexing module 201 having the above configuration, the lens holders 12 and 17 holding the aspherical lenses 14 and 19, the filter 21, and the spacers 11, 13, 16, and 18 are inserted into the cylindrical body 22 to align central axes of the aspherical lenses 14 and 19 with each other, and distances between the filter 21 and the aspherical lenses 14 and 19 are kept constant by lengths of the lens holders 12 and 17 or spacers 13 and 16. Then, while an output of the output optical fiber 26 is monitored, the light emitting element 23 or the fiber array 27 is laterally moved to adjust optical axes of the light emitting element 23 or the fiber array 27.

However, in the conventional optical multiplexing/demultiplexing module 201, because the individual components are separately produced, a variation in size tends to occur among the individual components such as lens holders 12 and 17, and the spacers 11, 13, 16, and 18. Because only edges of the aspherical lenses 14 and 19 are fitted in the annular lens holders 12 and 17, a variation also tends to occur in positions and angles of the aspherical lenses 14 and 19 held by the lens holders 12 and 17. Further, because the filter 21 is merely sandwiched between the spacers 13 and 16, the filter tends to incline from the angle perpendicular to the central axes of the aspherical lenses 14 and 19. Therefore, even when the lens holders 12 and 17 in which the aspherical lenses 14 and 19 are held, the filter 21, and the spacers 11, 13, 16, and 18 are inserted into the cylindrical body 22 and assembled, there is a risk of generating a shift between the central axes of the aspherical lenses 14 and 19 or a variation in parallelism or distance between the aspherical lenses 14 and 19 and the filter 21. As a result, even when the positions of the light emitting element 23 and the fiber array 27 are moved to separately adjust the optical axis of the optical multiplexing/demultiplexing module 201 such that the output from the output optical fiber 26 becomes maximum, there is a limitation in uniformizing characteristics of the optical multiplexing/demultiplexing modules 201. When the variation is minimized to uniformize the characteristics of the optical multiplexing/demultiplexing modules 201, it is necessary that accuracy of each component be extremely enhanced in production, which results in a problem of production cost increase.

Patent Document 1: Japanese Patent Application Laid-Open No. 10-268157

### DISCLOSURE OF THE INVENTION

In view of the foregoing problems, an object of the present invention is to provide an optical multiplexer/demultiplexer and an optical multiplexing/demultiplexing module, in which the accuracy of parallelism or distance between the lens and the filter is enhanced and the variation in characteristics can be suppressed by integrally forming the lens and the filter. Another object of the present invention is to provide a method of producing an optical multiplexer/demultiplexer by which the adjustment operation can be performed collectively and efficiently.

### MEANS FOR SOLVING THE PROBLEMS

An optical multiplexer/demultiplexer according to a first aspect of the present invention is characterized in that a filter portion is provided in one of surfaces of a transparent support plate, a lens is integrally formed in a surface of the support plate opposite the filter portion, and a transparent spacer is bonded to the support plate with the lens sandwiched between the transparent spacer and the support plate. For example, the optical multiplexer/demultiplexer is an optical multiplexer/demultiplexer according to an embodiment shown in FIG. 25.

In the optical multiplexer/demultiplexer according to the first aspect of the present invention, the filter portion is provided on one end of the support plate and the lens is molded in the other end, so that the parallelism or distance between the lens and the filter portion can accurately be obtained. Therefore, the alignment operation of the fiber array and the like coupled to the optical multiplexer/demultiplexer can easily be performed. An optical fiber, a light emitting element, or the light sensitive element abuts on the outer surface of the spacer, whereby the distance between the optical fiber, etc. and the lens can be kept constant.

In the optical multiplexer/demultiplexer according to the first aspect of the present invention, preferably a lens different from the lens is provided in an outer surface of the filter portion. Accordingly, the light beam transmitted through the filter can be collected with the another lens, and the coupling efficiency with the optical fiber, the light emitting element, or the light sensitive element can be improved. For example, the above aspect is optical multiplexer/demultiplexers according to embodiments shown in FIGS. 26 and 27.

An optical multiplexer/demultiplexer according to a second aspect of the present invention is characterized in that a filter portion is sandwiched between a pair of transparent support plates, lenses are integrally molded in surfaces of the support plates opposite the filter portion respectively, and a transparent spacer is bonded to each of the support plates with the lens sandwiched between the transparent spacer and the support plate. For example, the optical multiplexer/demultiplexer is an optical multiplexer/demultiplexer according to an embodiment shown in FIG. 2.

In the optical multiplexer/demultiplexer according to the second aspect of the present invention, the lens is molded in the other surface of each of the pair of support plates between which the filter portion is sandwiched, the accuracy of parallelism or distance between the lens and the filter portion, the accuracy of distance between the lenses, or the accuracy of parallelism between the central axes can be improved. The optical fiber, the light emitting element, or the light sensitive element abuts on the outer surface of the spacer, whereby the distance between the optical fiber, etc. and the lens can be kept constant. Therefore, the alignment operation of the fiber array, etc. coupled to the optical multiplexer/demultiplexer can easily be performed.

In the optical multiplexer/demultiplexer according to the first and second aspects of the present invention, preferably a projection which is projected higher than the thickness of the lens is provided on the support plate. According to the above aspect, because the projection which is higher than the thickness of the lens is provided on the support plate, the projection is caused to abut on the spacer, whereby the spacer can be bonded to the support plate while the distance between the spacer and the support plate is kept constant. When the spacer is bonded to the support plate with the lens sandwiched therebetween, the projection abuts on the spacer to keep the distance between the spacer and the support plate constant, so that the contact between the lens and the spacer can be prevented to protect the lens.

In the optical multiplexer/demultiplexer according to the above aspects, it is preferred that the projection is formed around the lens so as to surround the lens, and the lens is sealed in a space surrounded by the support plate, the projection, and the spacer. When the lens is surrounded and sealed by the projection, dew formation or adhesion of dust can be prevented in the lens, and humidity resistance and a dust-proof property are improved in the optical multiplexer/demultiplexer.

In the optical multiplexer/demultiplexer according to the first and second aspects of the present invention, preferably each lens has the same shape. According to the above aspect, when the incident light beam passes through a portion out of the central axis of the lens and is outputted after passing through a portion out of the central axis of another lens, the beam cross section deformed by passing the former lens can be corrected by the latter lens.

In the optical multiplexer/demultiplexer according to the above aspects, preferably central axes of the respective lenses are shifted from each other. It is particularly preferred that the central axes of the lenses are shifted from each other according to the difference between the distances from the filter to the lenses. That is, the lenses are shifted from each other, and the position where the light beam is incident on the lens on the light beam incident side and the position where the light beam is outputted from the lens on the light beam outgoing side are located in the same region, so that the beam cross section equal to that of the incident light beam can be obtained in the outgoing light beam.

In the optical multiplexer/demultiplexer according to the first and second aspects of the present invention, preferably a plurality of lenses are provided in a surface substantially parallel to the filter portion according to the filter portion. According to the above aspect, the plurality of optical multiplexers/demultiplexers can integrally be formed and arrayed, and the plural sets of the light beams can be multiplexed and/or demultiplexed at one time. For example, the above aspect is an optical multiplexer/demultiplexer according to an embodiment shown in FIG. 32.

In the optical multiplexer/demultiplexer according to the second aspect of the present invention, preferably the filter portion has two filters arranged at right angles to each other, a light beam having a first wavelength range among incident light beams having three wavelength ranges is reflected from one of the filters and taken out to the outside, the light beam having the second wavelength range among the light beams having the second and third wavelength ranges transmitted through the one of the filters is transmitted through the other filter and taken out to the outside, and the light beam having the third wavelength range is reflected from the other filter and taken out to the outside. According to the above aspect, the optical multiplexer/demultiplexer can be formed with the small number of components, and a degree of freedom is high in the alignment, so that the low-loss optical multiplexer/demultiplexer for three wavelengths can be obtained. For example, the above aspect is an optical multiplexer/demultiplexer according to an embodiment shown in FIG. 28.

In the optical multiplexer/demultiplexer according to the first or the second aspect of the present invention, preferably the filter portion has two filters arranged in parallel with each other and a light reflecting surface, a light beam having a first wavelength range among incident light beams having three wavelength ranges is reflected from one of the filters and taken out to the outside, the light beam having the second wavelength range among the light beams having the second and third wavelength ranges transmitted through the one of the filters is transmitted through the other filter and taken out to the outside, and the light beam having the third wavelength range is reflected from the other filter and the light reflecting surface and taken out to the outside from the same side as the light beam having the second wavelength range. Even in the above aspect, the light beams having the three wavelengths can be multiplexed and/or demultiplexed, and the optical multiplexer/demultiplexer can be obtained with high degree of freedom in the alignment and low loss. Furthermore, in the above aspect, because the two filters are parallel, the positional relationship between the filters is easily obtained with high accuracy. The light beam which is transmitted through one of the filters and reflected from the other filter is reflected from the light reflecting surface and introduced to the same side as the light beam which is transmitted through both the filters. Therefore, the light beams having the second and third wavelength ranges transmitted through one of the filters can be received at the same position. For example, the above aspect is an optical multiplexer/demultiplexer according to an embodiment shown in FIG. 30.

An optical multiplexing/demultiplexing module according to a third aspect of the present invention is characterized in that one of end portions of the optical multiplexer/demultiplexer according to the first and second aspects is coupled to a light emitting portion or a light sensitive portion, and a fiber array including a plurality of optical fibers is coupled to the other end face of the optical multiplexer/demultiplexer. As used herein, the light emitting portion means a can-type light emitting component in which a light emitting diode (LED) chip or the like is sealed. The light sensitive portion means a can-type light sensitive component in which a photodiode chip, a phototransistor chip, or the like is sealed. In the optical multiplexing/demultiplexing module, the optical multiplexer/demultiplexer is integrally coupled to the light emitting portion or the light sensitive portion, so that the downsizing of the optical multiplexing/demultiplexing module can be achieved. Because the fiber array is coupled to the end face of the spacer, the distance between the fiber array and the lens can be kept constant, and the alignment operation between the fiber array and the optical multiplexer/demultiplexer is also easily performed. For example, the optical multiplexing/demultiplexing module is an optical multiplexing/demultiplexing module according to embodiments shown in FIGS. 35 to 42.

An optical multiplexing/demultiplexing module according to a fourth aspect of the present invention is characterized in that, using the optical multiplexer/demultiplexer according to the first aspect in which parallel light beam is outputted from an end face on a filter side, an end portion on the filter side of the optical multiplexer/demultiplexer is attached to a light sensitive portion while inclined, the light sensitive portion including a lens in an opening thereof. With the optical multiplexing/demultiplexing module, the parallel light outputted from the end face on the filter side of the optical multiplexer/demultiplexer according to the first aspect is collected with the lens provided in the opening of the light sensitive portion, and the collected light can be received at the light sensitive element arranged at the center of the light sensitive portion. Moreover, in the optical multiplexing/demultiplexing module, because the light becomes the parallel light between the optical multiplexer/demultiplexer and the light sensitive portion, the alignment is easily performed between the optical multiplexer/demultiplexer and the light sensitive portion. For example, the optical multiplexing/demultiplexing module is an optical multiplexing/demultiplexing module according to an embodiment shown in FIG. 35.

An optical multiplexing/demultiplexing module according to a fifth aspect of the present invention is characterized in that an end portion on a filter side of the optical multiplexer/demultiplexer according to the first aspect is attached to a light sensitive portion, a light beam inputted to the filter is collected in the vicinity of the filter, and the light beam is received in the light sensitive portion before the light beam widely spreads. With the optical multiplexing/demultiplexing module, the light beam outputted from the end face on the filter side of the optical multiplexer/demultiplexer according to the first aspect can be received by the light sensitive element in the light sensitive portion before the light beam widely spreads, and the light sensitive portion can be coupled to the optical multiplexer/demultiplexer with the minimum lens configuration. For example, the optical multiplexing/demultiplexing module is an optical multiplexing/demultiplexing module according to an embodiment shown in FIG. 39.

An optical multiplexing/demultiplexing module according to a sixth aspect of the present invention is characterized in that one of end portions of the optical multiplexer/demultiplexer according to the first and second aspects is attached to a light emitting portion or a light sensitive portion with a central axis of the optical multiplexer/demultiplexer shifted from the center of the light emitting portion or the light sensitive portion. Because the light beam outputted from the optical multiplexer/demultiplexer according to the second aspect is outputted from the position shifted from the center of the optical multiplexer/demultiplexer, the central axis of the optical multiplexer/demultiplexer according to the second aspect is shifted from the center of the light sensitive portion, so that the light beam outputted from the optical multiplexer/demultiplexer according to the second aspect can be received by the light sensitive element provided at the center of the light sensitive portion. On the contrary, the light beam outputted from the light emitting element provided at the center of the light emitting portion can be incident on the light beam input position of the optical multiplexer/demultiplexer according to the second aspect. For example, the optical multiplexing/demultiplexing module is an optical multiplexing/demultiplexing module according to embodiments shown in FIGS. 40 and 41.

An optical multiplexing/demultiplexing module according to a seventh aspect of the present invention is characterized in that fiber arrays are coupled to both end faces of the optical multiplexer/demultiplexer according to the second aspect, the fiber array including a plurality of optical fibers. In the optical multiplexing/demultiplexing module, the fiber array is coupled to the spacer of the optical multiplexer/demultiplexer according to the second aspect, so that the distance between the lens and the fiber array can be kept constant, and the alignment operation between the lens and the fiber array can easily be performed. For example, the optical multiplexing/demultiplexing module is an optical multiplexing/demultiplexing module according to embodiments shown in FIGS. 3, 11, and 14.

An optical multiplexing/demultiplexing module according to an eighth aspect of the present invention is characterized in that a fiber array is coupled to one of end faces of the optical multiplexer/demultiplexer according to the first aspect or one or both end faces of the optical multiplexer/demultiplexer according to the second aspect, a plurality of optical fibers being arrayed in an annular shape in the fiber array. In the optical multiplexing/demultiplexing module, the plurality of optical fibers are arrayed in the annular shape around the one lens, so that the optical multiplexer/demultiplexer can be arrayed by one lens or one set of lenses. For example, the optical multiplexing/demultiplexing module is an optical multiplexing/demultiplexing module according to an embodiment shown in FIG. 33.

A method according to a ninth aspect of the present invention for producing the optical multiplexer/demultiplexer according to the first aspect includes: providing the filter portion in one of surfaces of a first wafer which constitutes the support plate; molding the plurality of lenses in the other surface of the first wafer; bonding a second wafer which constitutes the spacer to the first wafer such that the whole of the lens is sandwiched between the first wafer and the second wafer; and cutting the laminated body to produce the individual optical multiplexer/demultiplexer by dicing, the plurality of lenses being sandwiched between the first and second wafers in the laminated body. For example, the producing method according to the ninth aspect is a method of producing an optical multiplexer/demultiplexer according to embodiments shown in FIGS. 4 and 8.

According to the optical multiplexer/demultiplexer producing method according to the ninth aspect, the plurality of optical multiplexers/demultiplexers can collectively be produced, and the cost reduction can be achieved for the optical multiplexer/demultiplexer. Furthermore, the lens and the filter are provided in both the surfaces of the first wafer which constitutes the support plate, so that the parallelism and distance between the lens and the filter can accurately be obtained.

A method according to a tenth aspect of the present invention for producing the optical multiplexer/demultiplexer according to the second aspect includes: providing the filter portion in one of surfaces of a first wafer which constitutes the support plate; molding the plurality of lenses in the other surface of the first wafer; bonding a second wafer which constitutes the spacer onto the first wafer with the lens located between the first and second wafers; bonding another first wafer which constitutes the support plate to the first wafer with the filter portion located between the another first wafer and the first wafer; molding another set of plural lenses in an exposed surface of the another first wafer; laminating another second wafer which constitutes the spacer to another first wafer with the another lens located between the another second wafer and the another first wafer, and forming a laminated body; and cutting the laminated body to produce the individual optical multiplexer/demultiplexer by dicing. For example, the producing method according to the tenth aspect is a method of producing an optical multiplexer/demultiplexer according to embodiments shown in FIGS. 15 and 16.

According to the optical multiplexer/demultiplexer producing method according to the tenth aspect, the plurality of optical multiplexers/demultiplexers can collectively be produced, and the cost reduction can be achieved for the optical multiplexer/demultiplexer. The wafers are integrally laminated to form the lens and the filter, so that the position adjustment between the lenses, the distance adjustment between the lenses, the parallelism adjustment between the lens and the filter, and the distance adjustment between the lens and the filter can accurately be performed.

A method according to an eleventh aspect of the present invention for producing the optical multiplexer/demultiplexer according to the second aspect includes: providing the filter portion in one of surfaces of a first wafer which constitutes the support plate; molding the plurality of lenses in the other surface of the first wafer; bonding a second wafer which constitutes the spacer to the first wafer such that the whole of the lens is sandwiched between the first wafer and the second wafer; producing an interim component by dicing the laminated body in which the plurality of lenses are sandwiched between the first and second wafers; and producing the individual optical multiplexer/demultiplexer by bonding the surfaces in which the filter portion of the interim component is provided. For example, the producing method is a method of producing an optical multiplexer/demultiplexer according to embodiments shown in FIGS. 4 to 9.

According to the optical multiplexer/demultiplexer producing method according to the eleventh aspect, the plurality of optical multiplexers/demultiplexers can collectively be produced, and the cost reduction can be achieved for the optical multiplexer/demultiplexer. Particularly, because the interim component on one side and the interim component on the other side can simultaneously be produced, the optical multiplexer/demultiplexer producing method can be simplified to achieve further cost reduction.

In the optical multiplexer/demultiplexer producing method according to the tenth aspect of the present invention, preferably the lens is molded by a molding process in which an ultraviolet curing resin is used. In the application of the semiconductor producing process, it is difficult to form the lenses on both surfaces of the laminated body. However, according to the ultraviolet curing resin molding process in which a stamper is used, the lenses can easily be molded in both the surfaces of the laminated body.

In the optical multiplexer/demultiplexer producing method according to the ninth to eleventh aspects of the present invention, preferably when the second wafer is bonded to the first wafer, a projection which is higher than the thickness of the lens is formed on a surface of the first wafer, and the second wafer is bonded to the projection. According to the above aspect, the first wafer and the second wafer can be bonded while an adhesive agent does not adhere to the lens or while the lens does not come into contact with the second wafer.

In the optical multiplexer/demultiplexer producing method according to the ninth to eleventh aspects of the present invention, preferably an adhesive agent is supplied between the projection and the second wafer by utilizing capillarity when the second wafer is bonded to the first wafer in which the lens is molded. According to the above aspect, even when the lens is not covered with a mask, the adhesive agent can be applied only to the projection while the adhesive agent does not adhere to the lens.

In the optical multiplexer/demultiplexer producing method according to the ninth to eleventh aspects of the present invention, preferably a groove for supplying the adhesive agent is formed in a portion adjacent to the projection of the first wafer, the adhesive agent bonding the first wafer to the second wafer. According to the above aspect, even when the lens is not covered with a mask, the adhesive agent can rapidly be applied only to the projection while the adhesive agent does not adhere to the lens.

The above described elements constituting the present invention may suitably be combined with one another.

### BRIEF DESCRIPTION OF THE DRAWINGS

FIG. 1 is a cross sectional view showing a conventional optical multiplexing/demultiplexing module.

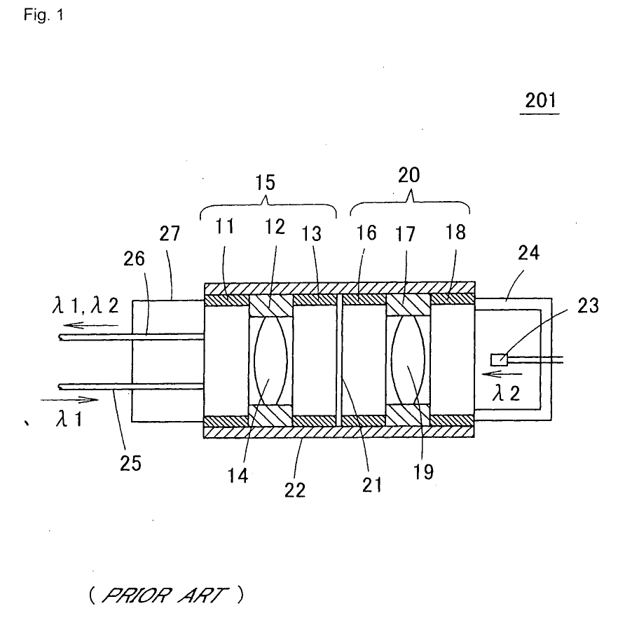

FIG. 2A is a perspective view showing an optical multiplexer/demultiplexer according to a first embodiment of the present invention, and FIG. 2B is a cross sectional view thereof.

FIG. 3 is a cross sectional view showing an optical multiplexing/demultiplexing module according to the first embodiment of the present invention.

FIGS. 4A, 4B, 4C, 4D, and 4E are cross sectional views showing a process of producing the optical multiplexer/demultiplexer according to the first embodiment.

FIG. 5 is a perspective view showing a state in which a lens and a seal portion are formed on a support plate.

FIG. 6A is a perspective view for explaining a process of injecting an adhesive resin between the seal portion and a spacer, and FIG. 6B is a cross sectional view thereof.

FIG. 7 is a perspective view showing the seal portion in which a resin flow groove is formed.

FIG. 8 is a perspective view showing a process of cutting a laminated body such as the support plate and the spacer.

FIG. 9 is a cross sectional view showing a process of bonding two half parts to produce the optical multiplexer/demultiplexer.

FIG. 10 is a cross sectional view showing a process of connecting fiber arrays to both ends of the optical multiplexer/demultiplexer to produce the optical multiplexing/demultiplexing module.

FIG. 11 is a cross sectional view showing the optical multiplexing/demultiplexing module accommodated in a sheath.

FIG. 12 is a cross sectional view showing a modification of the first embodiment of the present invention.

FIG. 13A is a perspective view showing an optical multiplexer/demultiplexer according to a second embodiment of the present invention, and FIG. 13B is a cross sectional view thereof.

FIG. 14 is a cross sectional view showing an optical multiplexing/demultiplexing module according to the second embodiment of the present invention.

FIGS. 15A, 15B, 15C, and 15D illustrate a process of producing the optical multiplexer/demultiplexer according to the second embodiment.

FIGS. 16A, 16B, 16C, and 16D illustrate a process subsequent to the process of FIG. 15.

FIGS. 17A, 17B, and 17C illustrate a process of producing the optical multiplexer/demultiplexer of the second embodiment, which is performed subsequent to the process of FIG. 16.

FIG. 18A is a perspective view showing a structure of an optical multiplexer/demultiplexer according to a third embodiment of the present invention, and FIG. 18B is a cross sectional view thereof.

FIG. 19 is a cross sectional view showing an optical multiplexing/demultiplexing module according to the third embodiment of the present invention.

FIGS. 20A, 20B, 20C, 20D, and 20E are process diagrams for explaining a method of producing the optical multiplexer/demultiplexer of the third embodiment.

FIG. 21 illustrates a process of laminating and integrating members produced in the process of FIGS. 20A to 20E.

FIG. 22 is a cross sectional view showing a stage before the optical multiplexer/demultiplexer according to the third embodiment is obtained by cutting.

FIG. 23A is a perspective view showing a modification of a fourth embodiment of the present invention, and FIG. 23B is a cross sectional view thereof.

FIG. 24 is a cross sectional view showing an optical multiplexing/demultiplexing module according to a fifth embodiment of the present invention.

FIG. 25A is a perspective view showing a modification of the fifth embodiment of the present invention, and FIG. 25B is a cross sectional view thereof.

FIG. 26 is a cross sectional view showing an optical multiplexing/demultiplexing module according to a sixth embodiment of the present invention.

FIG. 27A is a perspective view showing a modification of the sixth embodiment of the present invention, and FIG. 27B is a cross sectional view thereof.

FIG. 28 is a cross sectional view showing an optical multiplexing/demultiplexing module according to a seventh embodiment of the present invention.

FIG. 29 is an exploded cross sectional view showing an optical multiplexer/demultiplexer used in the optical multiplexing/demultiplexing module according to the seventh embodiment.

FIG. 30 is a cross sectional view showing an optical multiplexing/demultiplexing module according to an eighth embodiment of the present invention.

FIG. 31 is an exploded cross sectional view showing an optical multiplexer/demultiplexer used in the optical multiplexing/demultiplexing module according to the eighth embodiment.

FIG. 32 is a cross sectional view showing an optical multiplexing/demultiplexing module according to a ninth embodiment of the present invention.

FIG. 33 is a perspective view showing an optical multiplexing/demultiplexing module according to a tenth embodiment of the present invention when viewed from below.

FIG. 34 is a cross sectional view showing the optical multiplexing/demultiplexing module according to the tenth embodiment.

FIG. 35 is a cross sectional view showing an optical multiplexing/demultiplexing module according to an eleventh embodiment of the present invention.

FIG. 36 is a cross sectional view showing an optical multiplexing/demultiplexing module according to a twelfth embodiment of the present invention.

FIG. 37 is a cross sectional view showing an optical multiplexing/demultiplexing module according to a thirteenth embodiment of the present invention.

FIG. 38 is a cross sectional view showing an optical multiplexing/demultiplexing module according to a fourteenth embodiment of the present invention.

FIG. 39 is a cross sectional view showing an optical multiplexing/demultiplexing module according to a fifteenth embodiment of the present invention.

FIG. 40 is a perspective view showing an optical multiplexing/demultiplexing module according to a sixteenth embodiment of the present invention.

FIG. 41 is a cross sectional view showing the optical multiplexing/demultiplexing module according to the sixteenth embodiment.

FIG. 42 is a cross sectional view showing a modification of the sixteenth embodiment of the present invention.

### EXPLANATIONS OF LETTERS OR NUMERALS

31 spacer
32 lens support plate
33 support plate
34 filter
35 support plate
36 lens support plate
37 spacer
38 seal portion
39 lens
40 seal portion
41 lens
42 and 43 fiber array
44 input optical fiber
45a output optical fiber
45b output optical fiber
49a and 49b half part
50 recess
51 adhesive resin
52 resin flow groove
53 dicing blade
61 filter support plate
62 filter support plate
63 Fresnel lens
71 filter layer
73 filter
75 filter
77 mirror
80 mirror
91 light acceptance portion
97 light acceptance device
100 cap
101 ball lens
102 sleeve
107 Fresnel lens
115 Fresnel lens

### BEST MODE FOR CARRYING OUT THE INVENTION

Preferred embodiments of the present invention will be described in detail below with reference to the drawings. An optical multiplexer/demultiplexer and an optical multiplexing/demultiplexing module according to the present invention perform not only the demultiplexing operation for taking out an optical signal having each wavelength by demultiplexing an optical signal including light having a plurality of different wavelengths, but also the multiplexing operation for producing an optical signal including light having a plurality of wavelengths by multiplexing the light having the plurality of wavelengths. However, in the following embodiments, only the demultiplexing operation will be described.

### First Embodiment

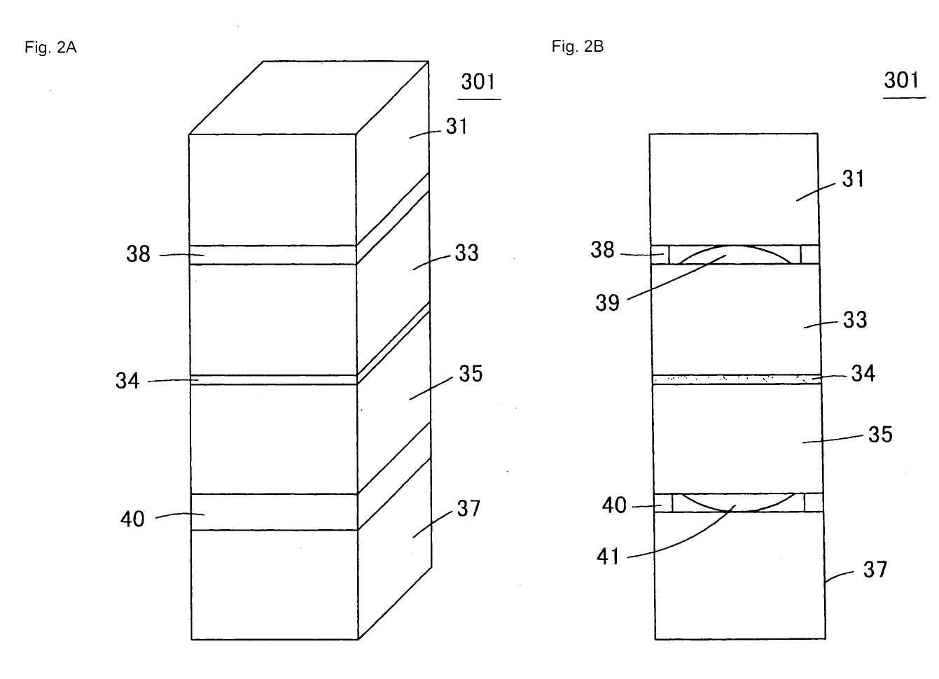

A first embodiment according to the present invention will be described below with reference to FIGS. 2 to 11.

(Configuration of First Embodiment)

FIG. 2A is a perspective view showing a configuration of an optical multiplexer/demultiplexer according to the first embodiment of the present invention, and FIG. 2B is a cross sectional view thereof. An optical multiplexer/demultiplexer 301 is formed by sequentially laminating and integrating a spacer 31, a seal portion 38 and a lens 39, a support plate 33, a filter 34, a support plate 35, a seal portion 40 and a lens 41, and a spacer 37, shown in order from the top in the figure. The optical multiplexer/demultiplexer 301 has a rectangular-solid appearance which is elongated in the laminated direction.

The lens 39 is molded integrally with a surface of the support plate 33 using a transparent ultraviolet curing resin, and is formed into a planoconvex lens whose one surface is flat. Similarly, the lens 41 is molded integrally with a surface of the support plate 35 using a transparent ultraviolet curing resin, and is formed into a planoconvex lens whose one surface is flat.

The spacer 31 is formed into a rectangular block by a transparent substrate, such as glass and plastic, which has a predetermined thickness. An optical communication component such as a fiber array is coupled to an end face of the spacer 31 in a use situation, and the spacer 31 serves to keep the distance between the optical communication component and the lens 39 constant.

The support plate 33 is formed into a rectangular block by a transparent substrate, such as glass and plastic, which has a predetermined thickness. The filter 34 is provided on a lower surface of the support plate 33, and the lens 39 is integrally molded on an upper surface of the support plate 33. Accordingly, the support plate 33 serves to keep the distance between the filter 34 and the lens 39 constant. The filter 34 may be provided on the lower surface of the support plate 33 by bonding the filter 34 to the support plate 33, or the filter 34 may be formed on the lower surface of the support plate 33 by evaporation.

The seal portion 38 (projection) is formed into a frame shape in an outer peripheral portion on the upper surface of the support plate 33. The height of the seal portion 38 is larger than the thickness of the lens 39, and the lens 39 is surrounded by the seal portion 38. The spacer 31 is bonded to the upper surface of the seal portion 38 provided on the upper surface of the support plate 33 using an adhesive agent. Accordingly, the lens 39 is accommodated in a space formed between the spacer 31 and the support plate 33 and is surrounded by the seal portion 38, so that the lens 39 is sealed in an airtight manner within the space surrounded by the spacer 31, the support plate 33, and the seal portion 38.

For example, the filter 34 (filter portion) is formed by a dielectric multi-layer film. The filter 34 has a filter property that reflects the light having a wavelength range including a wavelength λ1 and transmits the light having a wavelength range including another wavelength λ2.

The support plate 35 is formed into a rectangular block by a transparent substrate such as glass and plastic. The support plate 33 and the support plate 35 are integrally bonded while sandwiching the filter 34 therebetween and the lens 41 is integrally molded on the lower surface of the support plate 35. Accordingly, the support plate 35 serves to keep the distance between the filter 34 and the lens 41 constant.

The spacer 37 is formed into a rectangular block by a transparent substrate such as glass and plastic. An optical communication component such as a fiber array is coupled to the end face of the spacer 37 in a use situation, and the spacer 37 serves to keep the distance between the optical communication component and the lens 41 constant.

The seal portion 40 (projection) is also formed into a frame shape in the outer peripheral portion on the lower surface of the support plate 35. The height of the seal portion 40 is larger than the thickness of the lens 41, and the lens 41 is surrounded by the seal portion 40. The spacer 37 is bonded to the lower surface of the seal portion 40 provided on the lower surface of the support plate 35 using an adhesive agent. Accordingly, the lens 41 is accommodated in the space formed between the spacer 37 and the support plate 35 and is surrounded by the seal portion 40, so that the lens 41 is sealed in an airtight manner in the space surrounded by the spacer 37, the support plate 35, and the seal portion 40.

As described above, the heights of the seal portions 38 and 40 are larger than the thicknesses of the lenses 39 and 41. Therefore, when the spacers 31 and 37 are bonded to the seal portions 38 and 40, because the spacers 31 and 37 are never in contact with the lenses 39 and 41, a flaw is not generated in the lenses 39 and 41. Because the lenses 39 and 41 are accommodated inside the seal portions 38 and 40 and sealed in an airtight manner, the lenses are protected from humidity and dust. Therefore, dew formation does not occur and dust does not adhere to the lenses, which improves the humidity resistance and the dust-proof property.

The lenses 39 and 41 are formed in a spherical or aspherical lens having the same shape and have the same focal distance, and central axes of the lenses 39 and 41 are arranged so as to be aligned with each other. The spacer 31 is equal to the spacer 37 in the thickness, and the support plate 33 is equal to the support plate 35 in the thickness. The thicknesses of the spacers 31 and 37 and the support plates 33 and 35 and the shapes of the lenses 39 and 41 are set such that optical connection is well established between an optical fiber arranged near an exposed surface of the spacer 31 and an optical fiber arranged near an exposed surface of the spacer 37.

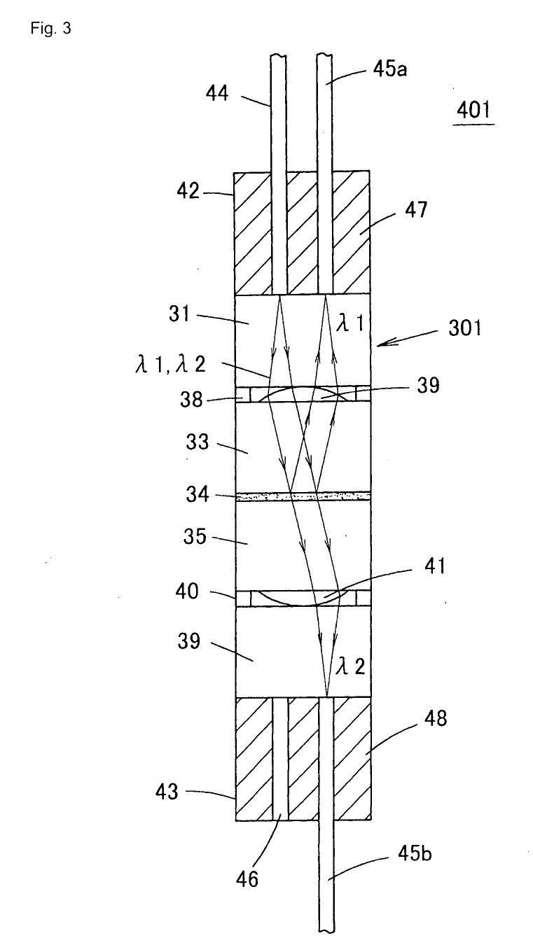

FIG. 3 is a cross sectional view showing an optical multiplexing/demultiplexing module 401 in which fiber arrays 42 and 43 are connected to both sides of the optical multiplexer/demultiplexer 301. The fiber array 42 is a two-core type fiber array in which end portions of two optical fibers (fiber cores) 44 and 45a are kept parallel in a holder 47. One of the optical fibers is an input optical fiber 44 and the other optical fiber is an output optical fiber 45a.

In the fiber array 43, an output optical fiber 45b is held in a holder 48. The fiber array 43 may be one in which only one output optical fiber 45b is held. Alternatively, as with the fiber array 42, a two-core type fiber array in which two optical fibers are held may be used, where one optical fiber 46 that is unused is cut, and the other optical fiber is used as the output optical fiber 45b.

Central axes of the lenses 39 and 41 pass through the center between the optical fibers 44 and 45a of the fiber array 42, and the central axes are aligned with a straight line parallel to the fiber central-axis direction of the optical fibers 44 and 45a. The fiber central axis of the output optical fiber 45b is adjusted so as to be aligned with the fiber central axis of the output optical fiber 45a. Accordingly, the fiber central axes of the input optical fiber 44 and the output optical fibers 45a and 45b pass through a frame portion which is located apart from the central axes of the lenses 39 and 41.

(Function of First Embodiment)

The multiplexing and demultiplexing operations in the optical multiplexing/demultiplexing module 401 according to the first embodiment will be described below with reference to FIG. 3. In FIG. 3, the light propagation direction is expressed by a thin arrow (the same holds true in the following drawings). As shown in FIG. 3, when the light beam (signal light) having the wavelength λ1 and the light beam (signal light) having the wavelength λ2 are superposed and outputted from the input optical fiber 44, the light beams having the wavelengths λ1 and λ2 outputted from the input optical fiber 44 are incident on the position off the central axis of the lens 39, and the light beams are converted into parallel light by the lens 39 while the directions of principal axis light beams are bent obliquely. Among the light beams included in the parallel light, the light beam having the wavelength λ1 is reflected and returned by the filter 34, and is incident on the position off the central axis of the lens 39. The light beam having the wavelength λ1 incident on the lens 39 is focused on the end face of the output optical fiber 45a by the lens 39, and is coupled to the output optical fiber 45a.

On the other hand, among the light beams incident on the filter 34, the light beam having the wavelength λ2 is transmitted through the filter 34 and incident on the position off the central axis of the lens 41. The light beam having the wavelength λ2 incident on the lens 41 is focused on the end face of the output optical fiber 45b by the lens 41, is coupled to the output optical fiber 45b. Therefore, in the optical multiplexing/demultiplexing module 401, the light beam having the wavelength λ1 and the light beam having the wavelength λ2 which are incident from the input optical fiber 44 are demultiplexed by the filter 34, and can be connected to the output optical fiber 45a and the output optical fiber 45b, respectively.

Contrary to the demultiplexing operation, when the light beam having the wavelength λ1 is inputted from the optical fiber 45a while the light beam having the wavelength λ2 is inputted from the optical fiber 45b, the multiplexing operation can be performed in such a manner that the light beam having the wavelength λ1 and the light beam having the wavelength λ2 are simultaneously connected to the end face of the optical fiber 44. In this case, the optical fibers 45a and 45b constitute the input optical fiber and the optical fiber 44 constitutes the output optical fiber (in the following embodiments, the description of the multiplexing operation is omitted).

(Producing Method of First Embodiment)

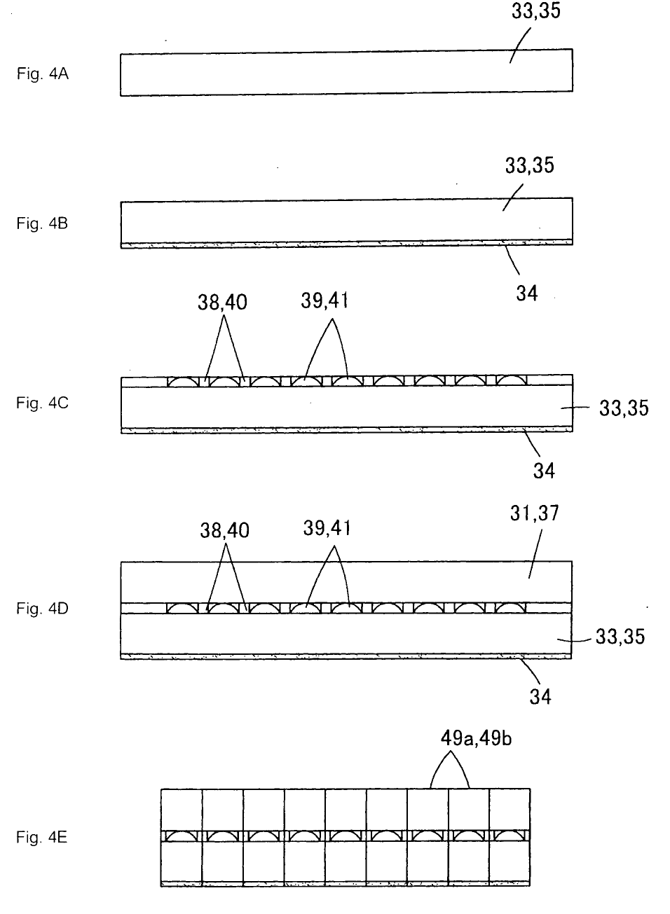

A method of producing the optical multiplexer/demultiplexer 301 and optical multiplexing/demultiplexing module 401 according to the first embodiment will be described below. FIGS. 4A to 4E, 5, 6A and 6B, and 7 to 11 are process diagrams showing processes of producing the optical multiplexer/demultiplexer 301 and the optical multiplexing/demultiplexing module 401. FIG. 4A shows a large-area support plate 33 or 35 having a size corresponding to a plurality of optical multiplexers/demultiplexers 301 or optical multiplexing/demultiplexing modules 401. The support plates 33 and 35 are formed by a transparent glass wafer or a transparent plastic plate. The filter 34 formed by a dielectric multi-layer film or the like is provided all over the lower surfaces of the support plates 33 and 35 (FIG. 4B).

An uncured transparent ultraviolet curing resin is dropped on the upper surfaces of the support plates 33 and 35, pressed with a stamper, and molded. Then, the ultraviolet curing resin is irradiated with an ultraviolet ray to be cured, and a plurality of seal portions 38 and 40 and lenses 39 and 41 are simultaneously molded on the upper surfaces of the support plates 33 and 35 (FIG. 4C).

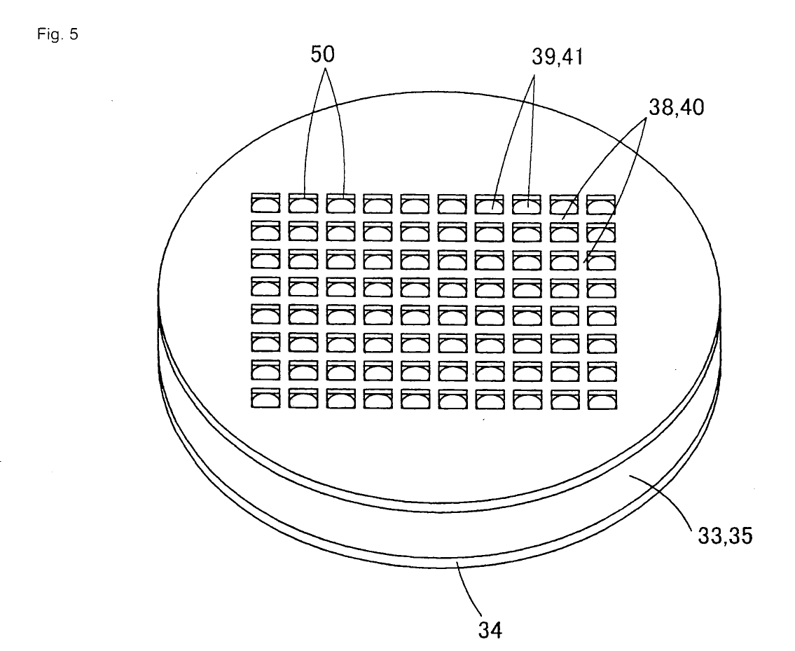

FIG. 5 is a perspective view showing the lens and lenses 39 and 41 and the seal portions 38 and 40 which are formed on the support plates 33 and 35 as described above. The seal portions 38 and 40 are spread not only on the surrounding portions of the lenses 39 and 41 but also on the whole region except the regions where the lenses 39 and 41 are formed. A plurality of recesses (opening) 50 are orderly arranged at a constant pitch in the seal portions 38 and 40 formed on the upper surfaces of the support plates 33 and 35, the seal portions 38 and 40 are formed in a grid shape so as to surround each recess 50, and the lenses 39 and 41 are accommodated in each recess 50. The heights of the seal portions 38 and 40 are larger than the thicknesses of the lenses 39 and 41.

Then, the spacers 31 and 37 having the sizes corresponding to a plurality of lenses are laminated on the seal portions 38 and 40 to bond the seal portions 38 and 40 to the spacers 31 and 37 (FIG. 4D). The spacers 31 and 37 are also formed by the transparent glass wafer or the transparent plastic plate. In order to bond the seal portions 38 and 40 and the spacers 31 and 37, it is necessary to apply an adhesive agent on the seal portions 38 and 40. However, when the adhesive agent is directly applied on the seal portions 38 and 40, the adhesive agent sticks to the lenses 39 and 41 to soil the lenses 39 and 41. In order to prevent sticking of the adhesive agent on the lenses 39 and 41, it is necessary to cover the lenses 39 and 41 with a mask, and the process becomes complicated.

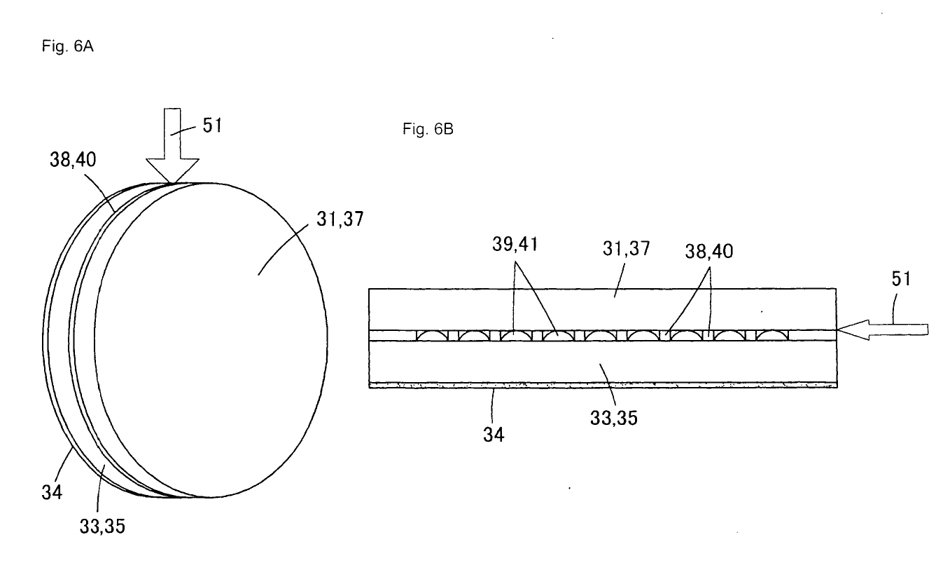

Therefore in the first embodiment, an adhesive resin 51 (adhesive agent) is supplied between the seal portions 38 and 40 and the spacers 31 and 37 by a method shown in FIGS. 6A and 6B (the method can also be applied to other embodiments). That is, after the spacers 31 and 37 are laminated on the seal portions 38 and 40, as shown in FIGS. 6A and 6B, the adhesive resin 51 is injected between the seal portions 38 and 40 and the spacers 31 and 37 using a dispenser or the like, is spread over the whole spaces between the seal portions 38 and 40 and the spacers 31 and 37 by utilizing capillarity, so that only the seal portions 38 and 40 are bonded to the spacers 31 and 37. As a result, the lenses 39 and 41 are confined in the spaces surrounded by the spacers 31 and 37, the support plates 33 and 35, and the seal portions 38 and 40, and the lenses 39 and 41 are sealed in an air tight manner.

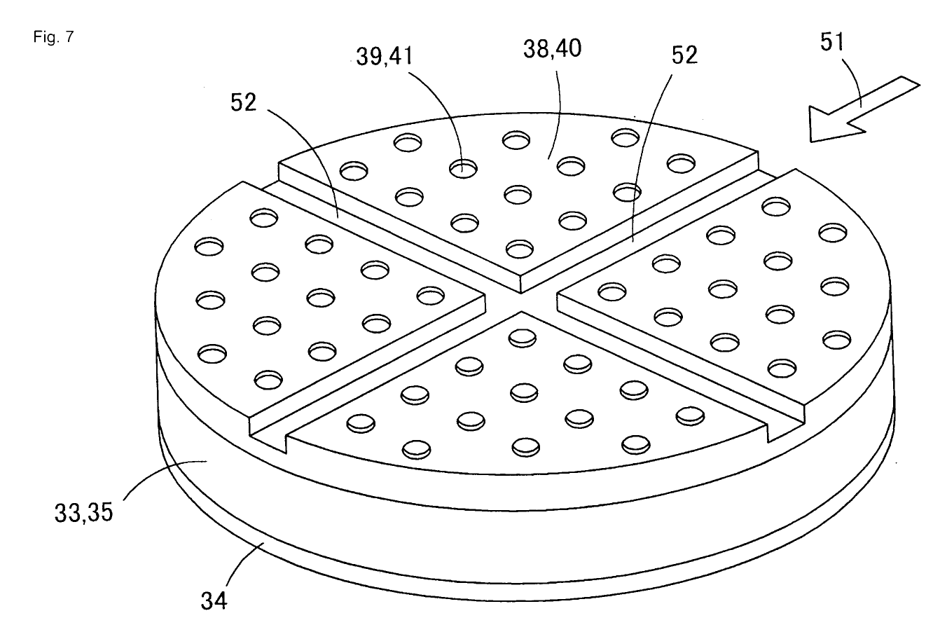

In order to easily spread the adhesive resin 51 between the seal portions 38 and 40 and the spacers 31 and 37, resin flow grooves 52 may be formed vertically and horizontally in regions adjacent to the seal portions 38 and 40 as shown in FIG. 7. Then, the adhesive resin 51 is poured in the resin flow grooves 52, and the adhesive resin 51 flowing along the resin flow grooves 52 is spread through gaps between the seal portions 38 and 40 and the spacers 31 and 37 through capillarity.

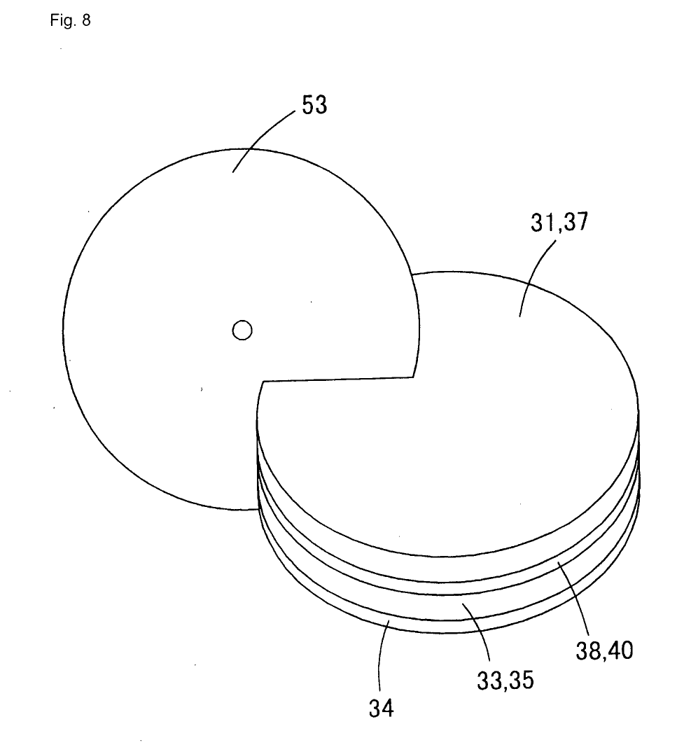

When the spacer 31, the seal portion 38, the lens 39, the support plate 33, and the filter 34 or the spacer 37, the seal portion 40, the lens 41, the support plate 35, and the filter 34 are laminated and integrated, as shown in FIG. 8, the laminated body is cut into each one piece of half part 49a or 49b (interim component) with a dicing blade 53 (FIG. 4E). In the present embodiment, because the half parts 49a and 49b are the same, the half parts 49a and 49b may be cut out from different laminated bodies, or a part of a laminated body may be used as the half part 49a while another part of the same laminated body is used as the half part 49b.

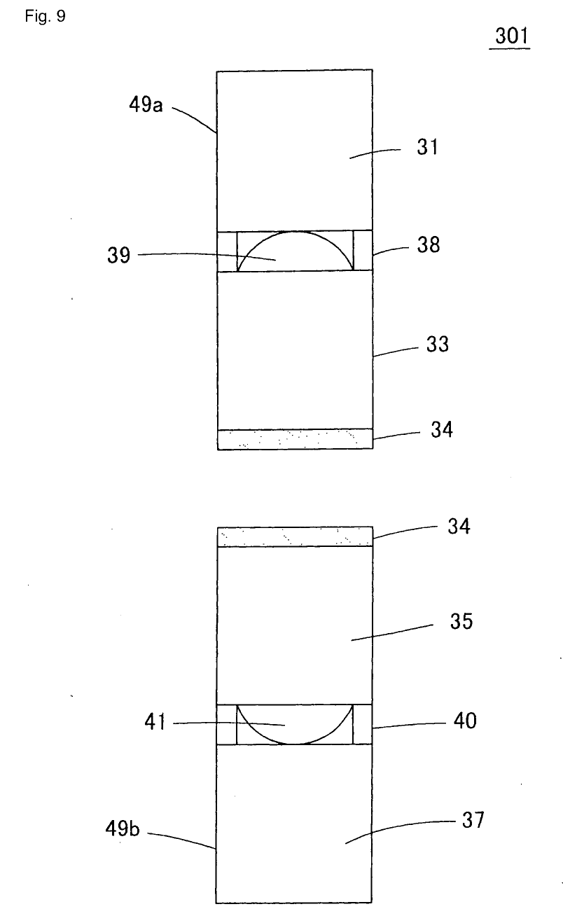

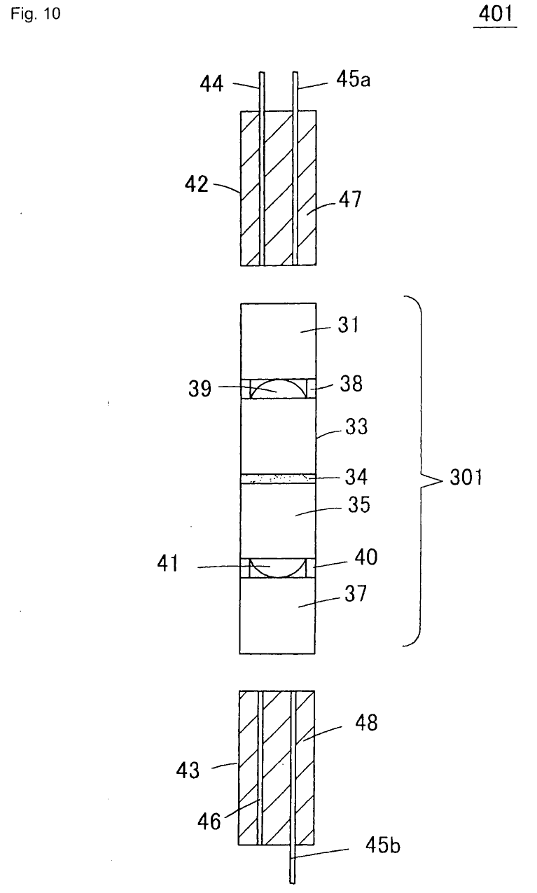

Thus, as shown in FIG. 9, after the one piece of half part 49a in which the spacer 31, the seal portion 38, the lens 39, the support plate 33, and the filter 34 are laminated and the one piece of half part 49b in which the spacer 37, the seal portion 40, the lens 41, the support plate 35, and the filter 34 are laminated are obtained, the filter 34 of the half part 49a and the filter 34 of the half part 49b are integrally bonded to obtain optical multiplexer/demultiplexer 301 as shown in FIG. 10.

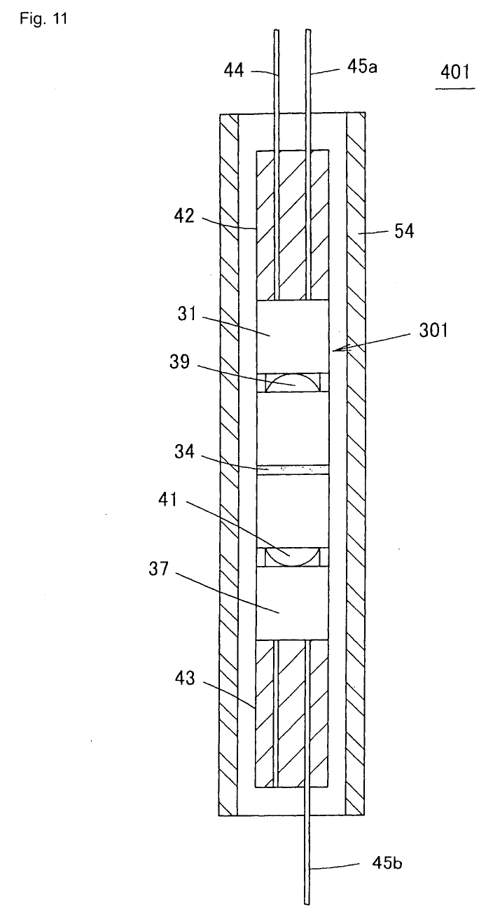

Then, while the input optical fiber 44 and the output optical fibers 45a and 45b are aligned with the central axes of the lenses 39 and 41, the two-core fiber array 42 is bonded to one end face of the optical multiplexer/demultiplexer 301, and the two-core fiber array 43 in which one optical fiber is cut is bonded to the other end face. As a result, the optical multiplexing/demultiplexing module 401 as shown in FIG. 11 is obtained. The optical multiplexing/demultiplexing module 401 may be accommodated in a cylindrical sheath 54 as shown in FIG. 11.

When there is a risk that the central axes of the lens 39 of the half part 49a and of the lens 41 of the half part 49b are shifted from each other due to insufficient accuracy of dicing the half parts 49a and 49b, passive bonding is performed by visually superposing the two lenses 39 and 41 on each other while viewing from the spacer surface, and then the remaining error may be eliminated by the alignment with the central axes of the optical fibers 44, 45a, and 45b.

(Effect of First Embodiment)

According to the first embodiment, parallelism between the lens 39 and the filter 34 is ensured by uniformity of the thickness of the support plate 33, and the accuracy of distance between the lens 39 and the fiber array 42 or the accuracy of distance between the lens 39 and the filter 34 is obtained by the thickness of the spacer 31 or the thickness of the support plate 33. Therefore, the alignment operation of the fiber array 42 or 43 with the optical multiplexer/demultiplexer 301 becomes easy and the accuracy of alignment is improved. As described in the above producing method, the wafers which constitute the spacer 31 and support plate 33 are laminated, and the plurality of lenses 39 and 41 are collectively formed during the lamination process, whereby the central axes of the plurality of lenses 39 and 41 can be collectively aligned with one another and the alignment operation is facilitated. Moreover, in the first embodiment, because the upper half and the lower half of the optical multiplexer/demultiplexer 301 have the same dimensions, the upper half (half part 49a) and the lower half (half part 49b) can collectively be produced to simplify the production process.

(Modification)

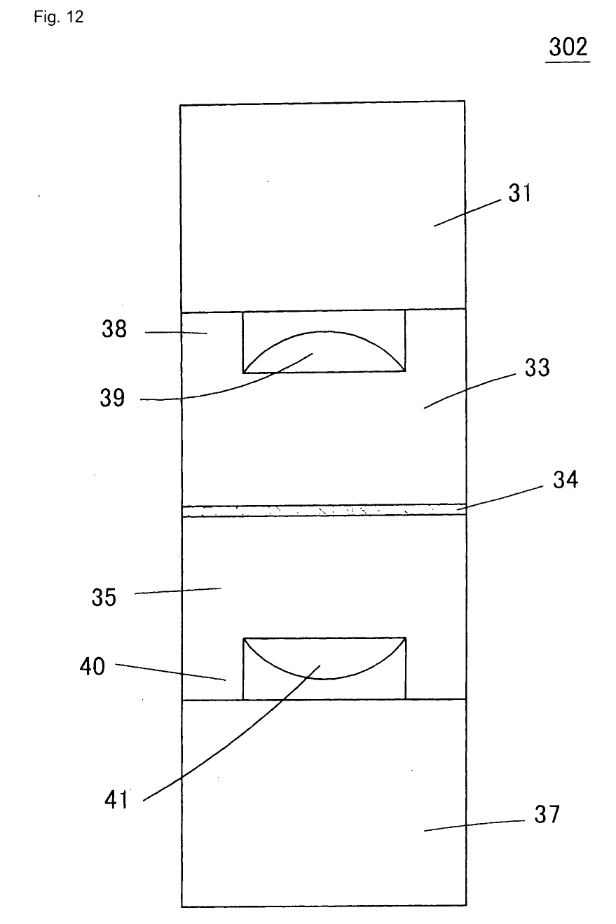

FIG. 12 is a cross sectional view showing a modification of the first embodiment. In an optical multiplexer/demultiplexer 302, the seal portion 38 is integrally formed with the support plate 33 by forming a recess in the support plate 33, and the seal portion 40 is integrally formed with the support plate 35 by forming a recess in the support plate 35. As will be described in the producing method of a fourth embodiment, a photolithography technique or etching may be used as the method of integrally forming the seal portions 38 and 40.

In the present modification, because the lens 39 is provided in the recess of the support plate 33, the support plate 33 is bonded to the spacer 31 with an adhesive agent or the like, and thereby the lens 39 is sealed in an airtight manner in the recess surrounded by the support plate 33, the seal portion 38, and the spacer 31. Similarly, because the lens 41 is provided in the recess of the support plate 35, the support plate 35 is bonded to the spacer 37 with an adhesive agent or the like, and thereby the lens 41 is sealed in an airtight manner in the recess surrounded by the support plate 35, the seal portion 40, and the spacer 37.

### Second Embodiment

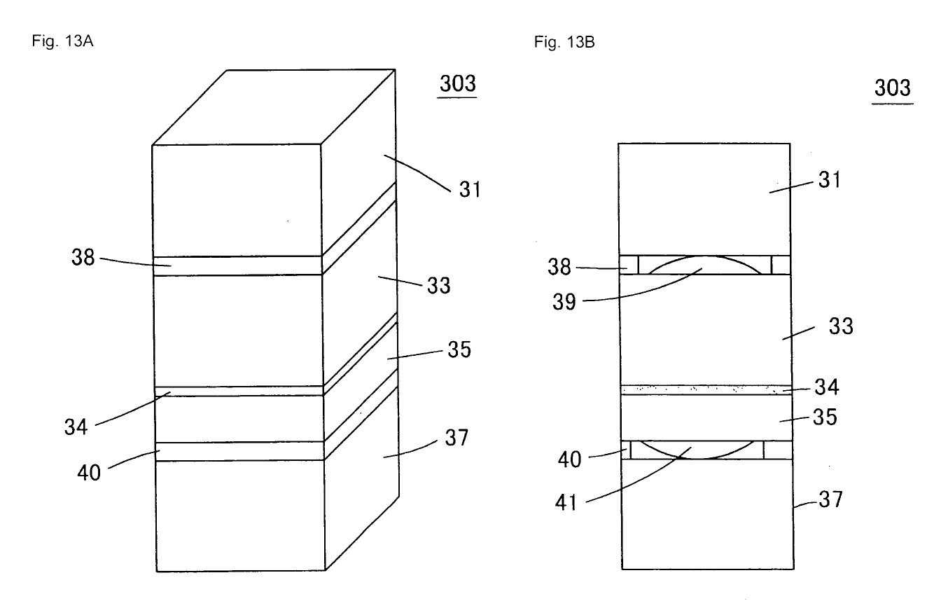

An optical multiplexer/demultiplexer according to a second embodiment will be described below. FIG. 13A is a perspective view showing an optical multiplexer/demultiplexer 303 according to the second embodiment, and FIG. 13B is a cross sectional view thereof. The second embodiment has a main feature that the upper half and the lower half of the optical multiplexer/demultiplexer 303 have different dimensions. The thicknesses of the spacers 31 and 37 are substantially equal to the focal distances of the lenses 39 and 41. On the other hand, because it is not always necessary that the thickness of the support plate 35 be equal to the focal distance of the lens 41, the thickness of the support plate 35 is formed shorter than the focal distance of the lens 41, which shortens the length of the optical multiplexer/demultiplexer 303 to realize a compact design.

The lens 39 and the lens 41 are formed in the same shape and have the same focal distance. Accordingly, the spacer 31 is substantially equal to the spacer 37 in the thickness. The central axes of the lenses 39 and 41 are shifted from each other.

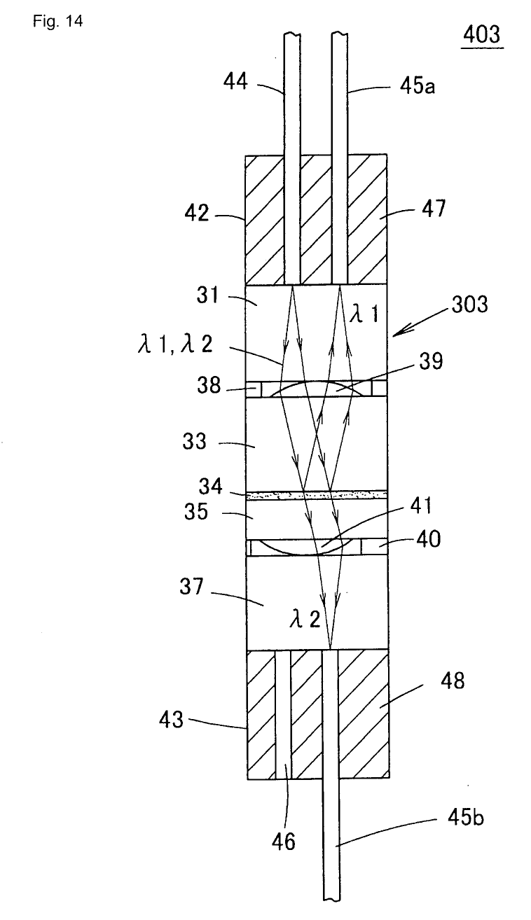

FIG. 14 is a cross sectional view showing an optical multiplexing/demultiplexing module 403 including the optical multiplexer/demultiplexer 303 according to the second embodiment. Similarly, in the optical multiplexing/demultiplexing module 403 according to the second embodiment, due to the same principle as in the first embodiment, the light beams having the wavelengths λ1 and λ2 which are inputted from the input optical fiber 44 are demultiplexed by the filter 34, the light beam having the wavelength λ1 is coupled to the output optical fiber 45a, and the light beam having the wavelength λ2 is coupled to the output optical fiber 45b. At this point, the central axis of the output optical fiber 45b is shifted from the central axis of the lens 41 such that the light beam transmitted through the lens 41 is perpendicularly incident on the output optical fiber 45b.

In the optical multiplexer/demultiplexer 303 or the optical multiplexing/demultiplexing module 403, because the light beam outgoing from the input optical fiber 44 is transmitted through the lens 39 at the position out of the central axis of the lens 39, the light beam transmitted through the lens 39 has a deformed beam cross section. Accordingly, in order to optimize the coupling efficiency with the output optical fiber 45b, it is necessary to correct the beam cross section with the lens 41. For this reason, the lens 41 has the same shape as the lens 39. Because it is necessary that the position at which the light beam is incident on the lens 39 and the position at which the light beam is outputted from the lens 41 be located in the same region in order to correct the beam cross section, the central axis of the lens 41 is shifted from the central axis of the lens 39 such that the position at which the light beam is incident on the lens 39 becomes identical to the position at which the light beam is outputted from the lens 41. Accordingly, the central axis of the lens 41 is shifted according to a difference in thickness between the support plate 33 and the support plate 35.

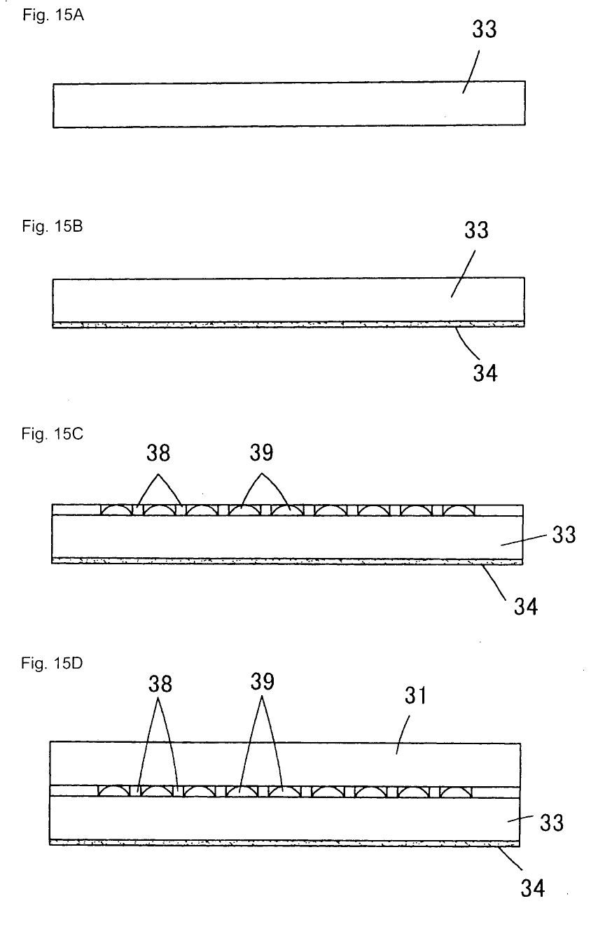

A method of producing the optical multiplexer/demultiplexer 303 and the optical multiplexing/demultiplexing module 403 according to the second embodiment will be described below. FIGS. 15A to 15D, FIGS. 16A to 16D, and FIGS. 17A to 17C are process diagrams showing processes of producing the optical multiplexer/demultiplexer 303 and the optical multiplexing/demultiplexing module 403 according to the second embodiment. Because the upper half and the lower half of the optical multiplexer/demultiplexer 303 according to the second embodiment have different dimensions, the method according to the first embodiment cannot be applied to the second embodiment, and thus the following producing method is employed.

The filter 34 is formed all over the lower surface of the large-area support plate 33 (glass wafer or the like is used) having the size corresponding to a plurality of optical multiplexers/demultiplexers 303 shown in FIG. 15A (FIG. 15B). Then, the lattice-shaped seal portion 38 and the plurality of lenses 39 are molded on the upper surface of the support plate 33 with the transparent ultraviolet curing resin by a stamper method (FIG. 15C). Then, the spacer 31 (glass wafer or the like is used) having the size corresponding to a plurality of optical multiplexers/demultiplexers 303 is laminated on the seal portion 38, and the spacer 31 is bonded to the upper surface of the seal portion 38 with an adhesive agent (FIG. 15D). At this point, because the height of the seal portion 38 is larger than the thickness of the lens 39, the lens 39 is not in contact with the spacer 31, and is confined in the space surrounded by the spacer 31, the support plate 33, and the seal portion 38, so that the lens 39 is sealed in an airtight manner.

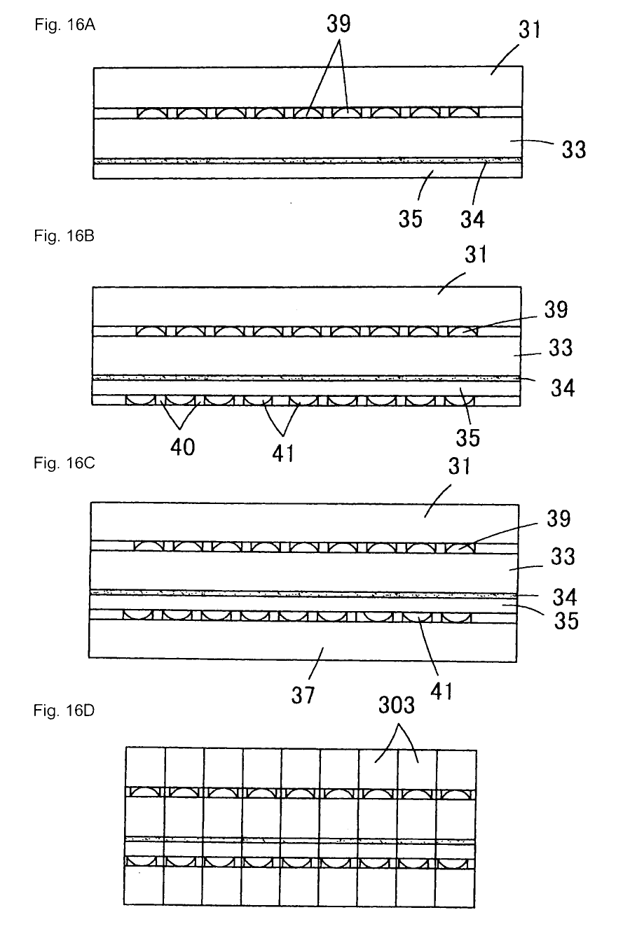

The large-area support plate 35 (glass wafer or the like is used) having the size corresponding to a plurality of optical multiplexers/demultiplexers 303 is bonded to the lower surface of the filter 34 (FIG. 16A), and the lattice-shaped seal portion 40 and the plurality of lenses 41 are molded on the lower surface of the support plate 35 using the transparent ultraviolet curing resin (FIG. 16B). At this point, the lens 41 is molded so as to be shifted from the lens 39 according to the difference in thickness between the support plate 33 and the support plate 35. Then, the spacer 37 (glass wafer or the like is used) having the size corresponding to a plurality of optical multiplexers/demultiplexers 303 is laminated on the lower surface of the seal portion 40, and the spacer 37 is bonded to the lower surface of the seal portion 40 with an adhesive agent (FIG. 16C). At this point, because the height of the seal portion 40 is larger than the thickness of the lens 41, the lens 41 is not in contact with the spacer 37 and is confined in the space surrounded by the spacer 37, the support plate 35, and the seal portion 40, so that the lens 41 is sealed in an airtight manner.

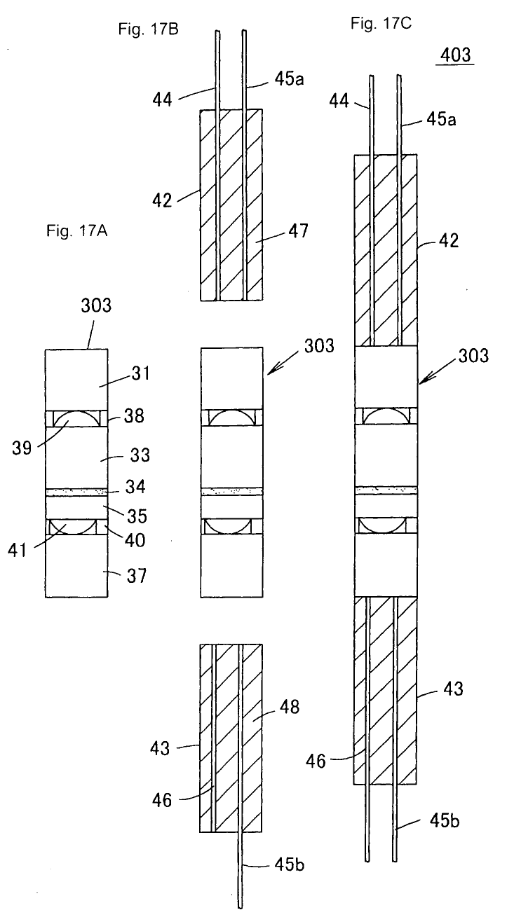

When the spacer 31, the seal portion 38, the lens 39, the support plate 33, the filter 34, the support plate 35, the seal portion 40, the lens 41, and the spacer 37 are laminated and integrated, the laminated body is cut into pieces with a dicer (FIG. 16D) to obtain the individual optical multiplexers/demultiplexers 303 (FIG. 17A). Then, the two-core fiber array 42 is bonded to one end face of the optical multiplexer/demultiplexer 303 while the input optical fiber 44 and the output optical fiber 45a are aligned with the central axis of the lens 39, and the fiber array 43 is bonded to the other end face of the optical multiplexer/demultiplexer 303 while the output optical fiber 45b is aligned with the central axis of the lens 41.

Similarly, in the second embodiment, the filters 34 and the lenses 39 are formed at both sides of the support plate 33, so that the parallelism or distance can correctly be obtained between the filter 34 and the lens 39 to facilitate the alignment operation in connecting the fiber array 42 and the like. Because the two lenses 39 and 41 are produced within the laminated body at the same time, the central axes of the lenses 39 and 41 are easily aligned with each other, and further the central axes of the plurality of lenses 39 and 41 can collectively be aligned with one another to facilitate the alignment operation.

The method of producing the optical multiplexer/demultiplexer according to the second embodiment (FIGS. 15 to 17) is not limited to the optical multiplexer/demultiplexer 303 having the structure as described in the second embodiment, and the method can also be applied to the optical multiplexer/demultiplexer 301 having the structure as described in the first embodiment.

### Third Embodiment

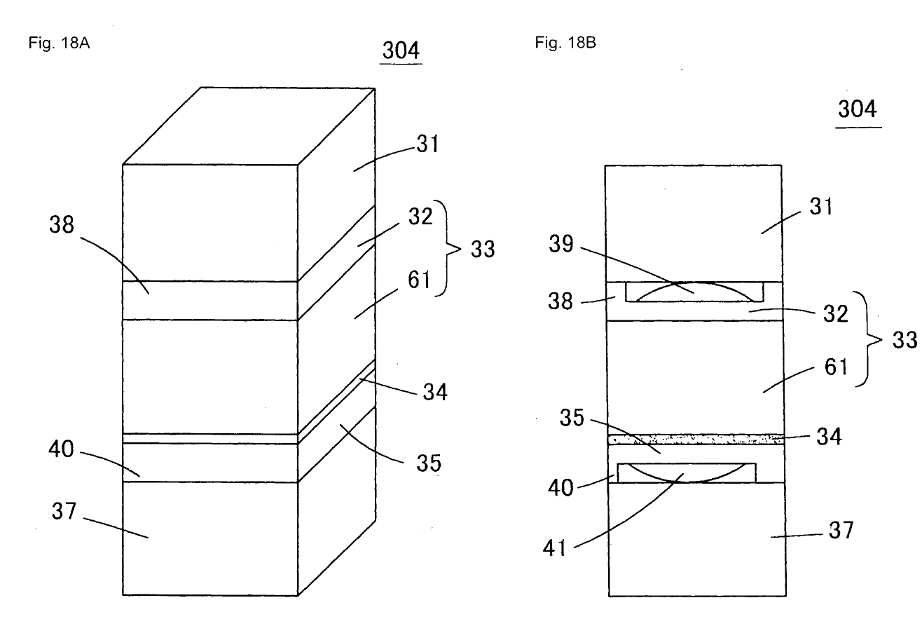

A structure of an optical multiplexer/demultiplexer according to a third embodiment of the present invention will be described below. FIG. 18A is a perspective view showing a structure of an optical multiplexer/demultiplexer 304 of the third embodiment, and FIG. 18B is a cross sectional view thereof. In the third embodiment, the thickness of the support plate 35 is decreased to realize a compact optical multiplexer/demultiplexer 304. Moreover, the support plate 33 is divided into the lens support plate 32 and the filter support plate 61 such that the lens support plate 32 and the support plate 35 have the same shape to achieve commonality of the component at a wafer stage.

In the present embodiment, the lens 39 is molded in the central portion on the upper surface of the transparent lens support plate 32, and the frame-shaped seal portion 38 is integrally formed on the upper surface of the lens support plate 32 so as to surround the lens 39. The lens 41 is molded at the position which is shifted from the center in the lower surface of the transparent support plate 35, and the frame-shaped seal portion 40 is integrally formed on the lower surface of the support plate 35 so as to surround the lens 41. The filter 34 is bonded to the lower surface of the filter support plate 61. In this case, the summation (i.e., the thickness of the support plate 33) of the thickness of a lens formation region of the lens support plate 32 and the thickness of the filter support plate 61 is substantially made equal to the focal distance of the lens 39.

Similarly, in the present embodiment, the lenses 39 and 41 are formed into the same shape, and have the same focal distance. The central axis of the lens 41 is shifted from the central axis of the lens 39 according to the difference in thickness between the support plate 33 and the support plate 35.

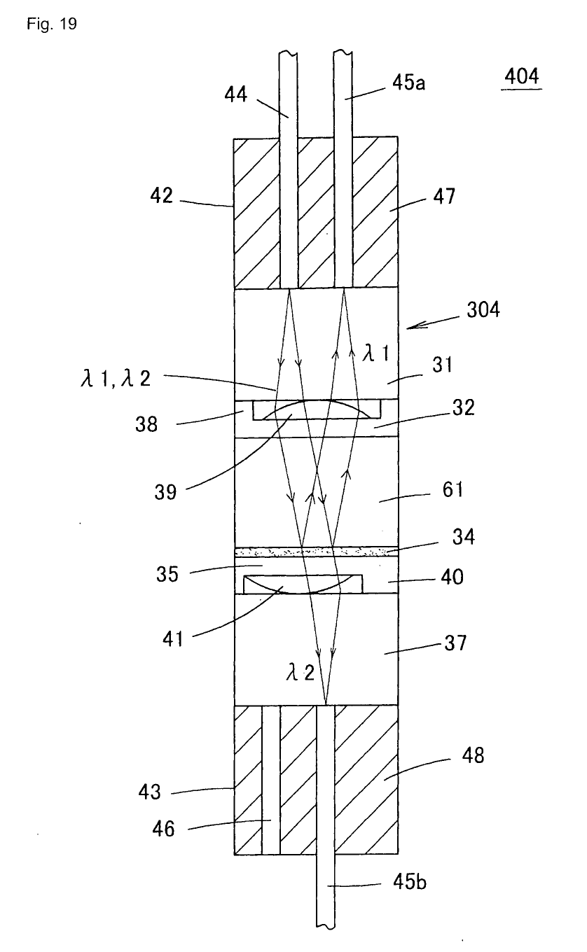

FIG. 19 is a cross sectional view showing an optical multiplexing/demultiplexing module 404 including the optical multiplexer/demultiplexer 304 according to the third embodiment. In the optical multiplexing/demultiplexing module 404 according to the third embodiment, due to the same principle as in the second embodiment, the light beams having the wavelengths λ1 and λ2 which are inputted from the input optical fiber 44 are demultiplexed by the filter 34, the light beam having the wavelength λ1, which is reflected by the filter 34, is coupled to the output optical fiber 45a, and the light beam having the wavelength λ2, which is transmitted through the filter 34, is coupled to the output optical fiber 45b.

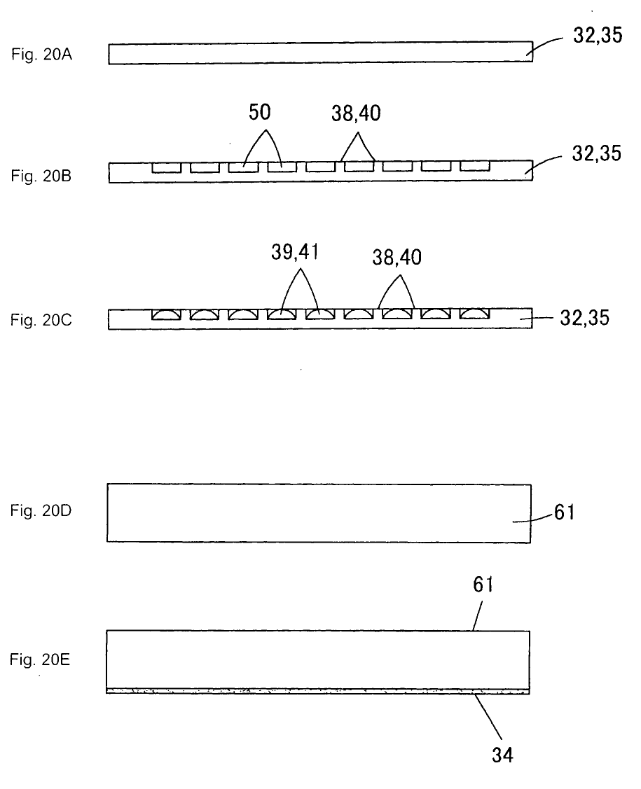

A method of producing the optical multiplexer/demultiplexer 304 according to the third embodiment will be described below. FIGS. 20A to 20E, 21, and 22 are process diagrams for explaining the method of producing the optical multiplexer/demultiplexer 304 according to the third embodiment. FIG. 20A shows the lens support plate 32 or the support plate 35 made of, e.g., a glass wafer and having the size corresponding to a plurality of optical multiplexers/demultiplexers 304. Recesses 50 surrounded by the lattice-shaped seal portions 38 and 40 are formed on the surfaces of the lens support plate 32 and the support plate 35 by a photolithography technique of etching (FIG. 20B).

Then, a glass material having a melting point lower than that of the lens support plate 32 or the support plate 35 is supplied into the recess 50 of the lens support plate 32 or the support plate 35, the molten glass material is molded into a spherical shape by its surface tension (melting method), and the lenses 39 and 41 are produced in each recess 50 (FIG. 20C).

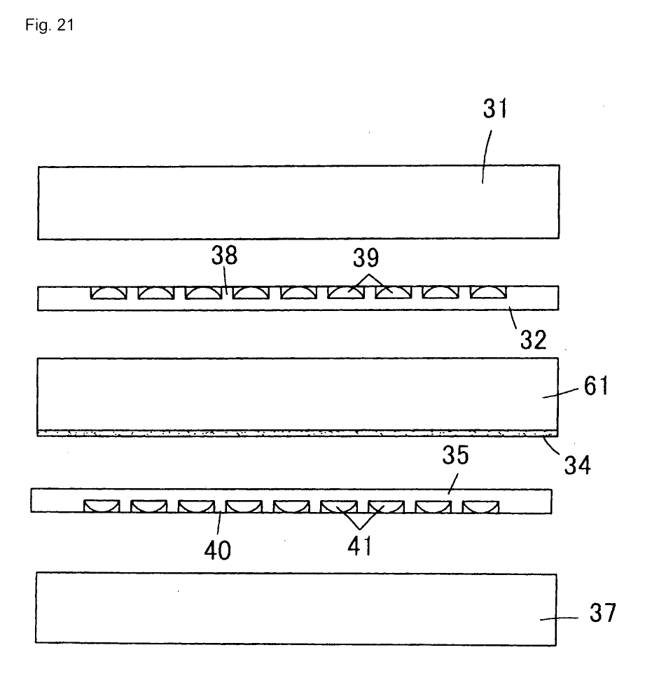

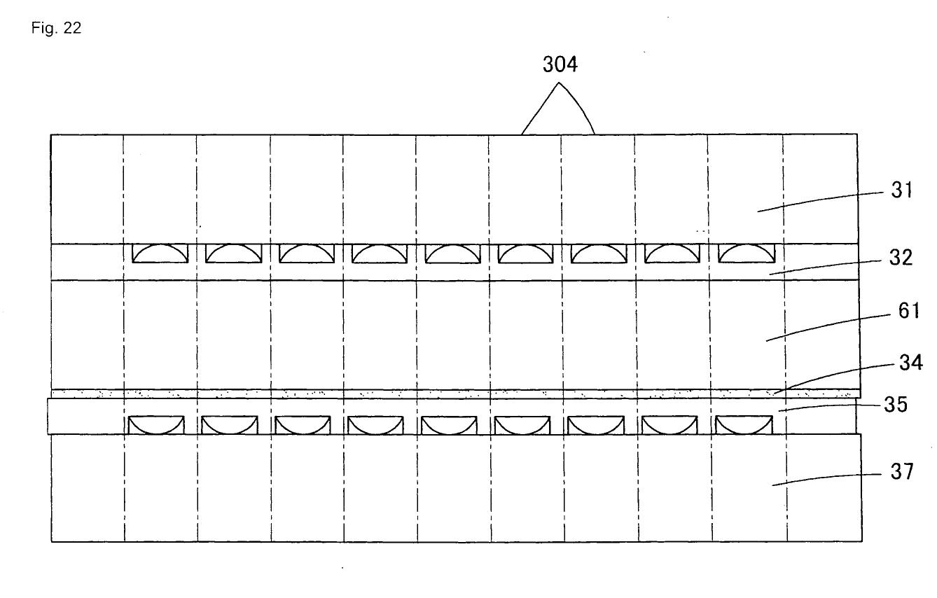

On the other hand, the filter 34 is bonded all over the lower surface of a large-area filter support plate 61 (made of a glass wafer and the like) having a size corresponding to a plurality of optical multiplexers/demultiplexers 304 shown in FIG. 20D (FIG. 20E). Then, as shown in FIG. 21, the large-area spacer 37, the large-area support plate 35 in which the lens 41 is molded, the filter support plate 61 on which the filter 34 is provided, the lens support plate 32 in which the lens 39 is molded, and the spacer 31 are sequentially laminated from the bottom and bonded to one another with an adhesive agent to form a laminated and integrated body, and thus the plurality of optical multiplexers/demultiplexers 304 are produced at one time. At this point, the lenses 39 and 41 are sealed in the recesses 50 in an airtight manner. Although the lens support plate 32 in which the lens 39 is formed is identical with the support plate 35 in which the lens 41 is formed, the support plate 35 is laminated while shifted from the lens support plate 32 by a predetermined amount. Then, the laminated body is cut into pieces along a cut line shown by an alternate long and short dash line in FIG. 22, and the individual optical multiplexers/demultiplexers 304 are obtained.

Similarly, in the third embodiment, the parallelism between the lens 39 and the filter 34 is ensured by the uniformity of the thicknesses of the lens support plate 32 and of the filter support plate 61, and, e.g., the accuracy of distance between the lens 39 and the fiber array 42 or the accuracy of distance between the lens 39 and the filter 34 is obtained by the thickness of the spacer 31 or the thicknesses of the lens support plate 32 and of the filter support plate 61. Therefore, the alignment operation of the fiber array 42 or 43 with the optical multiplexer/demultiplexer 304 becomes easy and the accuracy of alignment is improved. As described in the above producing method, the wafers which constitute the spacer 31, the lens support plate 32, and the filter support plate 61, etc. are laminated, and the plurality of lenses 39 and 41 are collectively formed during the lamination process, whereby the central axes of the plurality of lenses 39 and 41 are collectively aligned with one another to facilitate the alignment operation. Further, in the present embodiment, the lens support plate 32 and the support plate 35 have the same shape and size, and the lens 39 and the lens 41 have the same shape and size, so that the number of components can be decreased, thereby achieving cost reduction of the optical multiplexer/demultiplexer 304.

### Fourth Embodiment

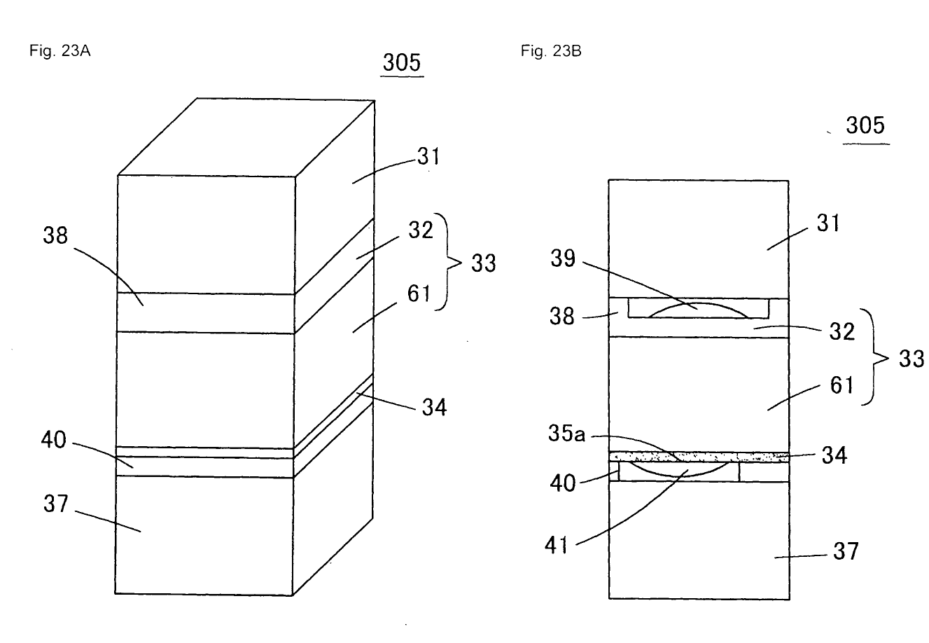

A structure of an optical multiplexer/demultiplexer according to a fourth embodiment of the present invention will be described below. FIG. 23A is a perspective view showing a structure of an optical multiplexer/demultiplexer 305 according to the fourth embodiment, and FIG. 23B is a cross sectional view thereof. In the fourth embodiment, the support plate 33 is divided into the lens support plate 32 and the filter support plate 61, and the lens 39 is provided in the lens support plate 32. The filter 34 is formed on the lower surface of the filter support plate 61, and the lens 41 and the seal portion 40 which are molded products are integrally bonded to the lower surface of the filter 34 with an adhesive agent 35a.

In the present embodiment, the lens 39 is molded in the central portion in the upper surface of the transparent lens support plate 32, and the frame-shaped seal portion 38 is integrally formed on the upper surface of the lens support plate 32 so as to surround the lens 39. The lens 41 is bonded at the position which is shifted from the center in the lower surface of the filter 34, and the frame-shaped seal portion 40 is bonded to the lower surface of the filter 34 so as to surround the lens 41. Similarly, in the present embodiment, the lenses 39 and 41 are formed into the same shape and have the same focal distance. The central axis of the lens 41 is shifted from the central axis of the lens 39 according to a difference in thickness between the support plate 33 and the adhesive agent 35a.

### Fifth Embodiment

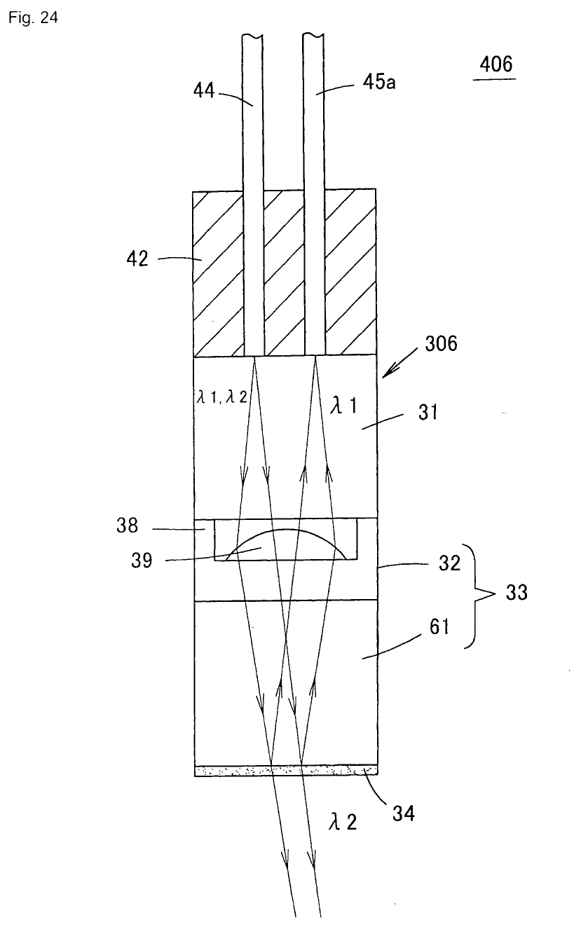

An optical multiplexer/demultiplexer according to a fifth embodiment of the present invention will be described below. FIG. 24 is a cross sectional view showing an optical multiplexing/demultiplexing module 406 including an optical multiplexer/demultiplexer 306 according to the fifth embodiment. The spacer 31, the lens support plate 32 in which the lens 39 is molded, and the filter support plate 61 on which the filter 34 is formed are sequentially laminated from the top in the optical multiplexer/demultiplexer 306 that is used here. The optical multiplexing/demultiplexing module 406 is configured by connecting the fiber array 42 to the upper surface of the optical multiplexer/demultiplexer 306. The fiber array may be connected to the lower surface of the optical multiplexer/demultiplexer 306, or a light sensitive portion or the like may be arranged opposite to the filter 34.

In the fifth embodiment, the light beams having the wavelengths λ1 and λ2 outgoing from the input optical fiber 44 are transmitted through the lens 39 and incident on the filter 34, and the light beam having the wavelength λ1 is reflected from the filter 34 and connected to the output optical fiber 45a. The light beam having the wavelength λ2 transmitted through the filter 34 is directly outputted in the form of the parallel light.

According to the present embodiment, because the lens support plate 32 in which the lens 39 is provided and the filter support plate 61 on which the filter 34 is formed are formed in the different plate (wafer), the production process becomes easy. Because only one lens is used, the optical multiplexer/demultiplexer 306 can be shortened and downsizing of the optical multiplexer/demultiplexer 306 can be achieved.

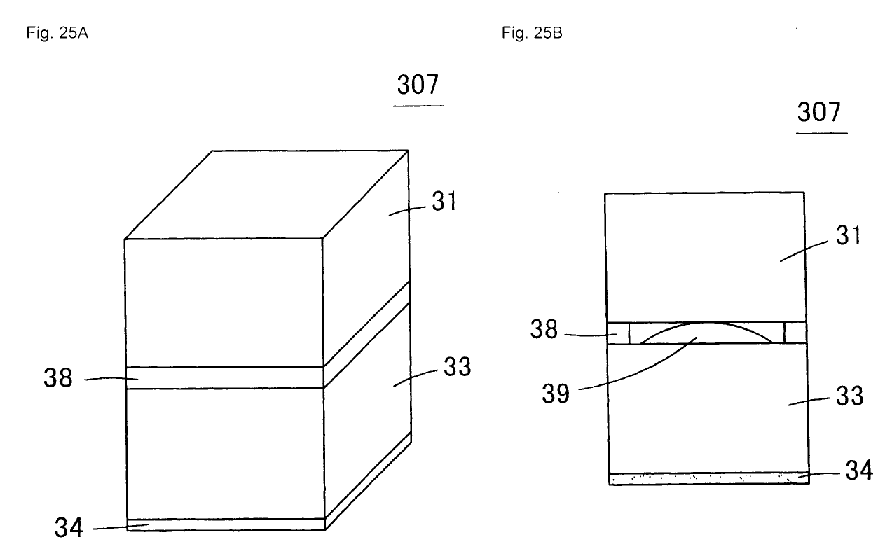

FIG. 25A is a perspective view showing a modification of the fifth embodiment, and FIG. 25B is a cross sectional view thereof. Although an optical multiplexer/demultiplexer 307 according to this modification has a structure similar to that of the fifth embodiment, the filter 34 is provided on the lower surface of the one support plate 33, and the lens 39 and the seal portion 38 are formed on the upper surface of the support plate 33.

### Sixth Embodiment

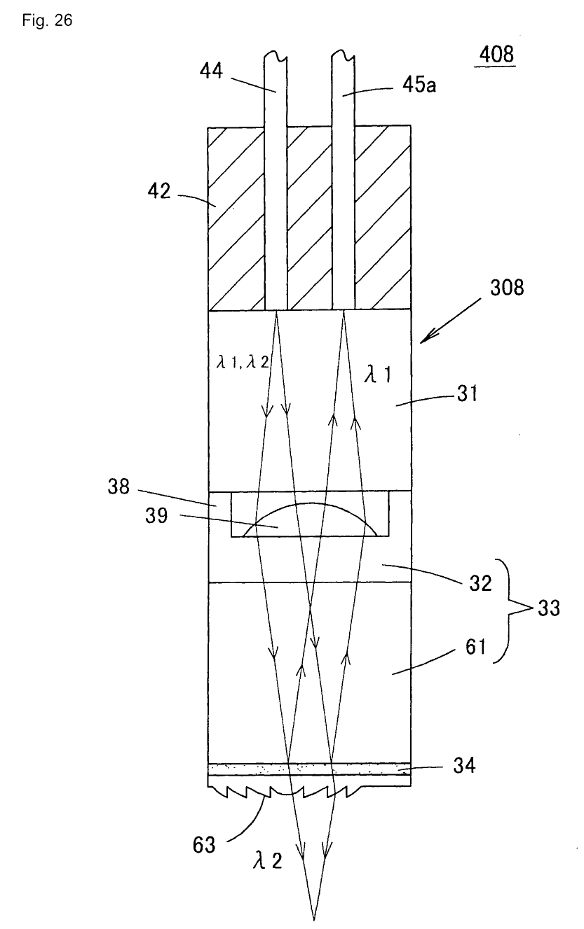

An optical multiplexer/demultiplexer according to a sixth embodiment of the present invention will be described below. FIG. 26 is a cross sectional view showing an optical multiplexing/demultiplexing module 408 including an optical multiplexer/demultiplexer 308 according to the sixth embodiment. In the optical multiplexer/demultiplexer 308 used here, a Fresnel lens 63 is bonded to the lower surface of the optical multiplexer/demultiplexer 306 according to the fifth embodiment, i.e., the outer surface of the filter 34.

Similarly, in the sixth embodiment, the light beams having the wavelengths λ1 and λ2 outgoing from the input optical fiber 44 are transmitted through the lens 39 and incident on the filter 34, and the light beam having the wavelength λ1 is reflected from the filter 34 and connected to the output optical fiber 45a. The light beam having the wavelength λ2 transmitted through the filter 34 is directly outputted while collected with the Fresnel lens 63.

According to the sixth embodiment, because the Fresnel lens 63 is directly bonded to the filter 34, the light beam outgoing from the filter side can be collected without lengthening the optical multiplexer/demultiplexer 306. Because of the use of the Fresnel lens 63, the outgoing light beam is collected and the optical multiplexer/demultiplexer 308 is easily connected to a device to which the light beam is outputted.

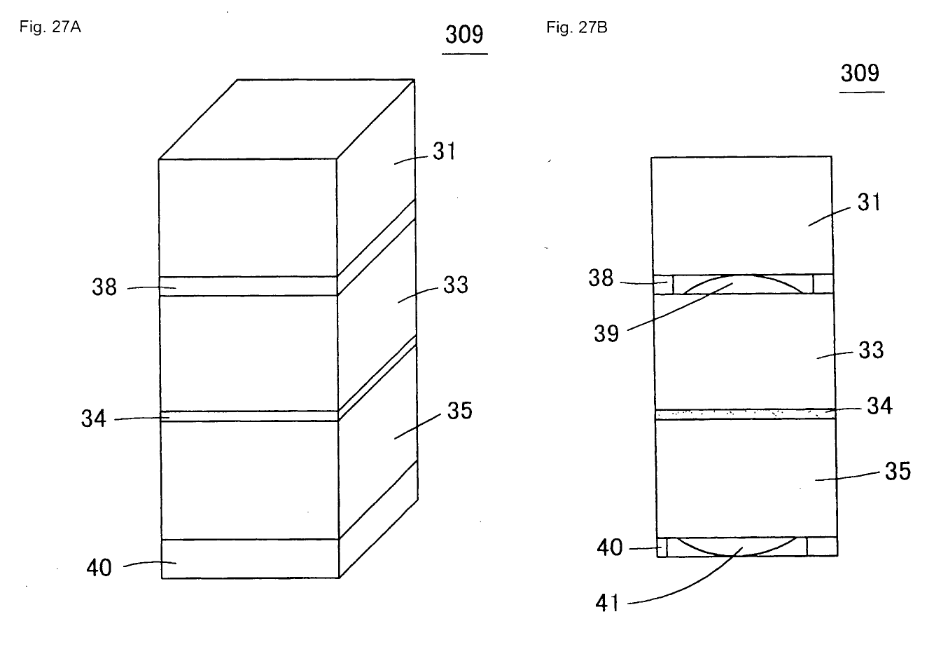

FIG. 27A is a perspective view showing an optical multiplexer/demultiplexer 309 according to a modification of the sixth embodiment, and FIG. 27B is a cross sectional view thereof. Instead of the Fresnel lens 63, the support plate 35 including the spherical or aspherical lens 41 is bonded to the lower surface of the filter 34.

### Seventh Embodiment

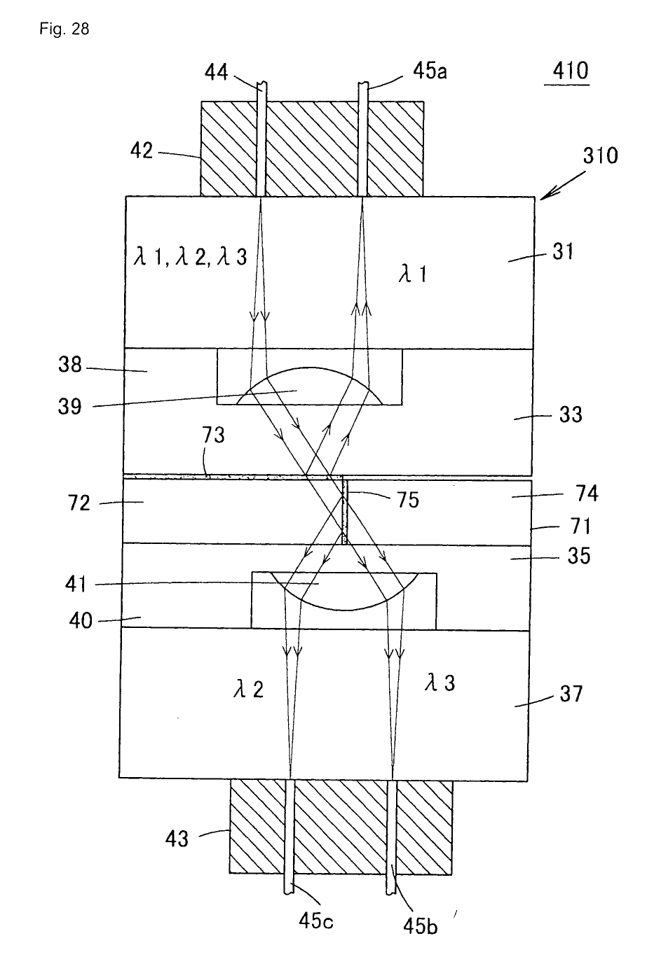

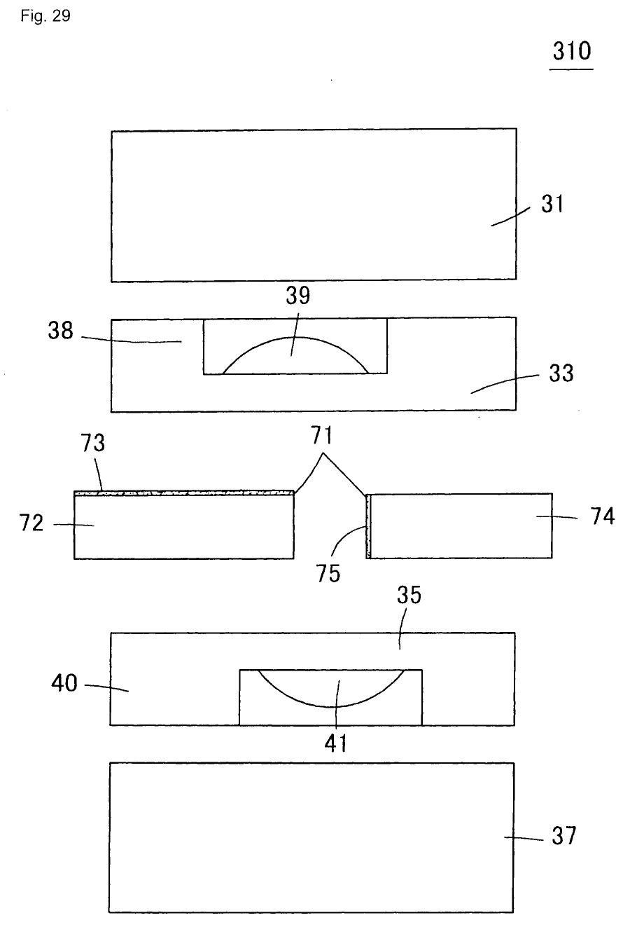

An optical multiplexer/demultiplexer according to a seventh embodiment of the present invention will be described below. FIG. 28 is a cross sectional view showing an optical multiplexing/demultiplexing module 410 including an optical multiplexer/demultiplexer 310 according to the seventh embodiment. FIG. 29 is an exploded cross sectional view of the optical multiplexer/demultiplexer 310. The support plate 33 in which the spacer 31 and the lens 39 are molded, a filter layer 71, the support plate 35 in which the lens 41 is molded, and the spacer 37 are laminated and integrated in the optical multiplexer/demultiplexer 310. The two-core fiber array 42 is coupled to the upper surface of the optical multiplexer/demultiplexer 310, and the two-core fiber array 43 is coupled to the lower surface, whereby the optical multiplexing/demultiplexing module 410 is constituted. The fiber array 42 holds the input optical fiber 44 and the output optical fiber 45a, and the fiber array 42 is arranged such that the midpoint between the optical fibers 44 and 45a is aligned with the central axis of the lens 39. The fiber array 43 holds the output optical fiber 45b and the output optical fiber 45c, and the fiber array 43 is arranged such that the midpoint between the optical fibers 45b and 45c is aligned with the central axis of the lens 41. The lenses 39 and 41 are arranged such that the central axes thereof are laterally shifted from each other.

As shown in FIG. 29, the filter layer 71 is formed by laterally arranging rectangular filter blocks 72 and 74 having the same thickness, a filter 73 is formed on the upper surface of the filter block 72, and a filter 75 is formed on a side face of the filter block 74. Accordingly, the filter 73 and the filter 75 are arranged at right angles to each other. The filter 73 reflects the light beam having a wavelength range centered on the wavelength λ1 and transmits the light beam having a wavelength range centered on the wavelengths λ2 and λ3, among the light beams having the wavelengths λ1, λ2, and λ3 incident from the input optical fiber 44. The filter 75 reflects the light beam having a wavelength range centered on the wavelength λ2 and transmits the light beam having a wavelength range centered on the wavelength λ3. The filters 73 and 75 are located in an optical path of the light beam which goes to the lens 41 after being transmitted through the lens 39.

In optical multiplexer/demultiplexer 410 according to the seventh embodiment, the multiplexing/demultiplexing operation on the incident light beam is performed as shown in FIG. 28. In the optical multiplexing/demultiplexing module 410, the light beams having the wavelengths λ1, λ2, and λ3 inputted from the input optical fiber 44 are converted into parallel light by the lens 39 and are incident on the filter 73. Among the light beams incident on the filter 73, the light beam having the wavelength λ1 is reflected by the filter 73 and incident on the lens 39, and is coupled to the output optical fiber 45a.

On the other hand, the light beams having the wavelengths λ2 and λ3 transmitted through the filter 73 are incident on the filter 75, and the light beam having the wavelength λ2 is reflected from the filter 75, is incident on the lens 41, and is coupled to the output optical fiber 45c. Among the light beams incident on the filter 75, the light beam having the wavelength λ3 is transmitted through the filter 75, is incident on the lens 41, and is coupled to the output optical fiber 45b.

Accordingly, in the optical multiplexing/demultiplexing module 410, the light beams having the three wavelengths λ1, λ2, and λ3 which are incident from the input optical fiber 44 can be demultiplexed to be outputted from the output optical fibers 45a, 45b, and 45c respectively. And besides, the filter block 72 on which the filter 73 is formed and the filter block 74 on which the filter 75 is formed are laterally arranged to form the filter layer 71 in which the two filters 73 and 75 are arranged at right angles to each other, so that the filter layer 71 can easily be produced with a high degree of accuracy.

### Eighth Embodiment

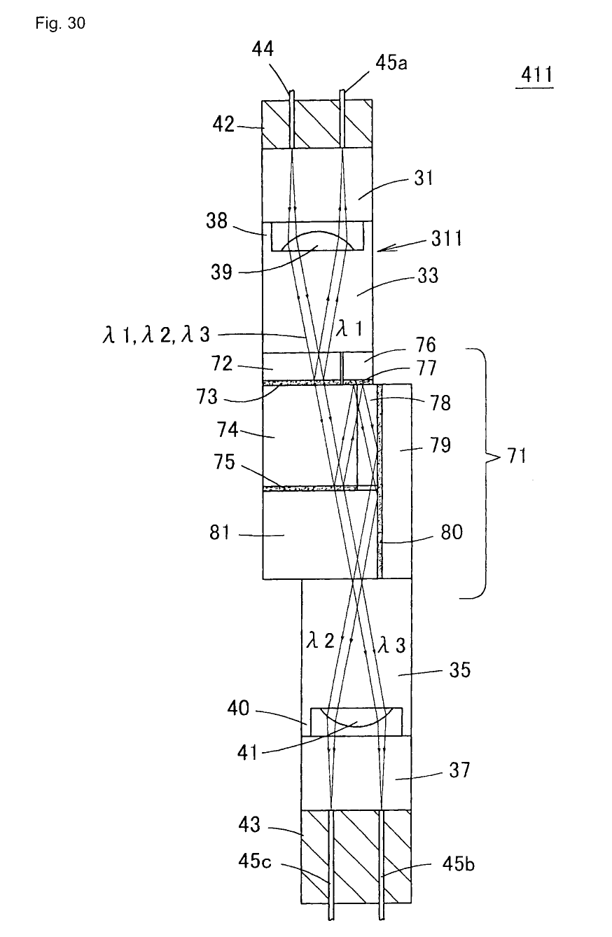

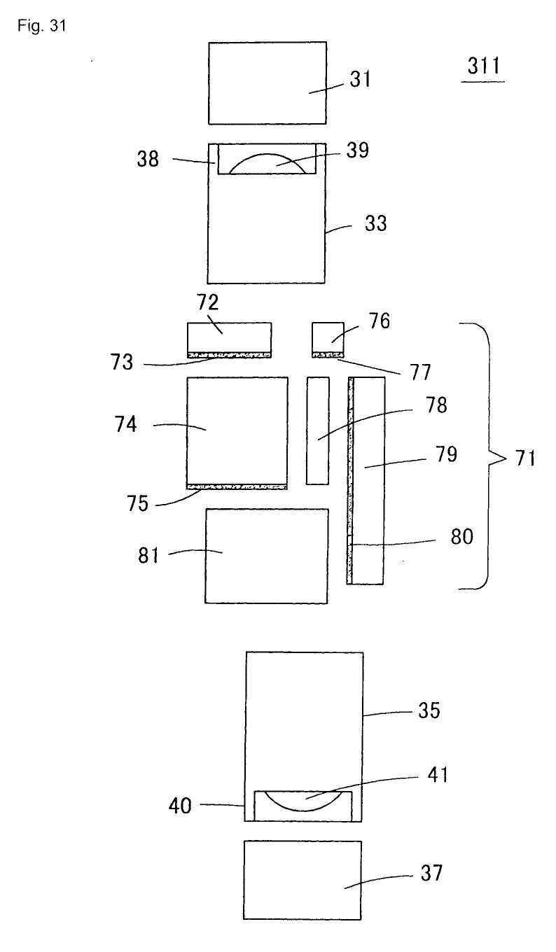

An optical multiplexer/demultiplexer according to an eighth embodiment of the present invention will be described below. FIG. 30 is a cross sectional view showing an optical multiplexing/demultiplexing module 411 including an optical multiplexer/demultiplexer 311 according to the eighth embodiment. FIG. 31 is an exploded cross sectional view of the optical multiplexer/demultiplexer. The spacer 31, the support plate 33 in which the lens 39 is molded, the filter layer 71, the support plate 35 in which the lens 41 is molded, and the spacer 37 are laminated and integrated in the optical multiplexer/demultiplexer 311. The two-core fiber array 42 is coupled to the upper surface of the optical multiplexer/demultiplexer 311, and the two-core fiber array 43 is coupled to the lower surface, whereby the optical multiplexing/demultiplexing module 411 is constituted. The optical multiplexing/demultiplexing module 411 has substantially the same configuration as the optical multiplexing/demultiplexing module 405 according to the seventh embodiment except that the filter layer 71 has a different structure.

As shown in FIG. 31, the filter layer 71 is formed by combining the filter block 72 having the filter 73 on the lower surface, the filter block 74 having the filter 75 on the lower surface, a block 76 in which a mirror 77 is formed on the lower surface, a transparent block 78, a block 79 on which a mirror 80 is formed on the side face, and a transparent block 81. Accordingly, the filters 73 and 75 and the mirror 77 are arranged in parallel with each other, and the mirror 80 is arranged at a right angle to the filters 73 and 75 and the mirror 77. In this case also, the filter 73 reflects the light beam having a wavelength range centered on the wavelength λ1 and transmits the light beams having a wavelengths range centered on the wavelengths λ2 and λ3, among the light beams having the wavelengths λ1, λ2, and λ3 incident from the input optical fiber 44. The filter 75 reflects the light beam having a wavelength range centered on the wavelength λ2 and transmits the light beam having a wavelength range centered on the wavelength λ3. A filter for reflecting the light beams having the wavelength range of the wavelength λ2 may be used instead of the mirrors 77 and 80.

In the optical multiplexer/demultiplexer 411 according to the eighth embodiment, the demultiplexing operation of the incident light beam is performed as shown in FIG. 30. In the optical multiplexing/demultiplexing module 411, the light beams having the wavelengths λ1, λ2, and λ3 inputted from the input optical fiber 44 are converted into parallel light by the lens 39 and are incident on the filter 73. Among the light beams incident on the filter 73, the light beam having the wavelength λ1 is reflected by the filter 73, is incident on the lens 39, and is coupled to the output optical fiber 45a.

On the other hand, the light beams having the wavelengths λ2 and λ3 transmitted through the filter 73 are incident on the filter 75, the light beam having the wavelength λ2 is reflected from the filter 75, further reflected by the mirrors 77 and 80 and incident on the lens 41, and is coupled to the output optical fiber 45c. Among the light beams incident on the filter 75, the light beam having the wavelength λ3 is transmitted through the filter 75, is incident on the lens 41, and is coupled to the output optical fiber 45b.

Accordingly, in the optical multiplexing/demultiplexing module 411, the light beams having the three wavelengths λ1, λ2, and λ3 which are incident from the input optical fiber 44 can be demultiplexed to be outputted from the output optical fibers 45a, 45b, and 45c respectively.

### Ninth Embodiment

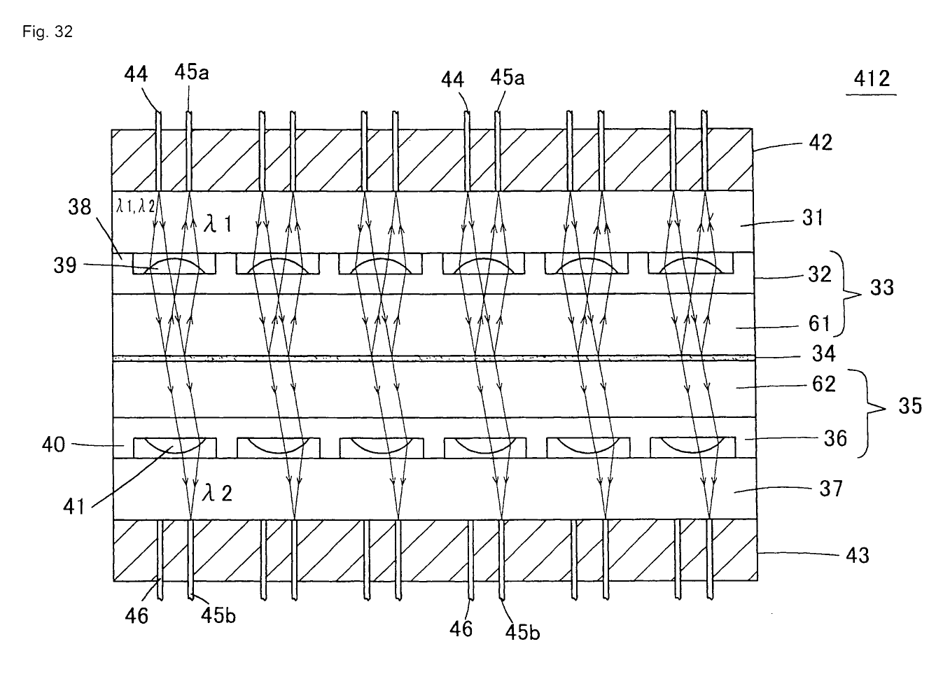

An optical multiplexing/demultiplexing module according to a ninth embodiment of the present invention will be described below. FIG. 32 is a cross sectional view showing an optical multiplexing/demultiplexing module 412 according to the ninth embodiment. In the optical multiplexing/demultiplexing module 412, the plurality of optical multiplexing/demultiplexing modules are integrated and arrayed. The optical multiplexing/demultiplexing module 412 shown in FIG. 32 has a structure in which the plurality of optical multiplexer/demultiplexers are laterally arranged in line. In the optical multiplexer/demultiplexer, the filter 34 is sandwiched between the support plate 33 and the support plate 35, the lens 39 is molded in the lens support plate 32 and the spacer 31 is bonded thereon, and the lens 41 is molded in the lens support plate 36 and the spacer 37 is bonded thereunder. The support plate 33 includes the lens support plate 32 and the filter support plate 61, and the support plate 35 includes the lens support plate 36 and the filter support plate 62. In FIG. 32, the filter 34 of one type is provided. However, when the property of the filter 34 is varied in each region, the optical multiplexing/demultiplexing modules having different properties can be integrated and arrayed.

In the optical multiplexing/demultiplexing module 412 having the above structure, the lens support plates 32 and 36 in which the lenses 39 and 41 are formed and the filter support plates 61 and 62 on which the filter 34 is formed are separately formed. Therefore, it is only necessary to process only one side of the wafer, and the production process is simplified. The upper half and the lower half are formed in a symmetrical relation, shared use of the members can be achieved.

### Tenth Embodiment

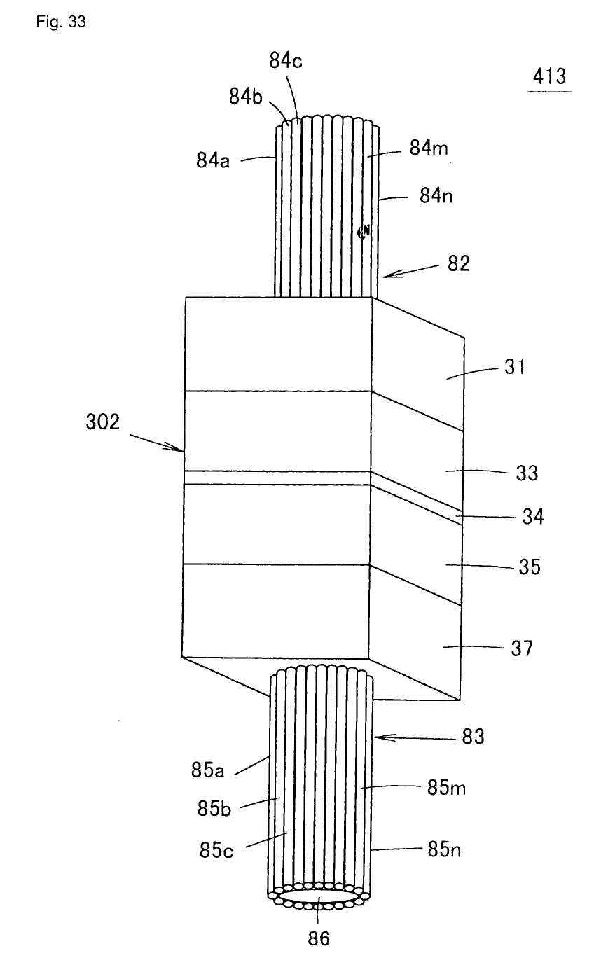

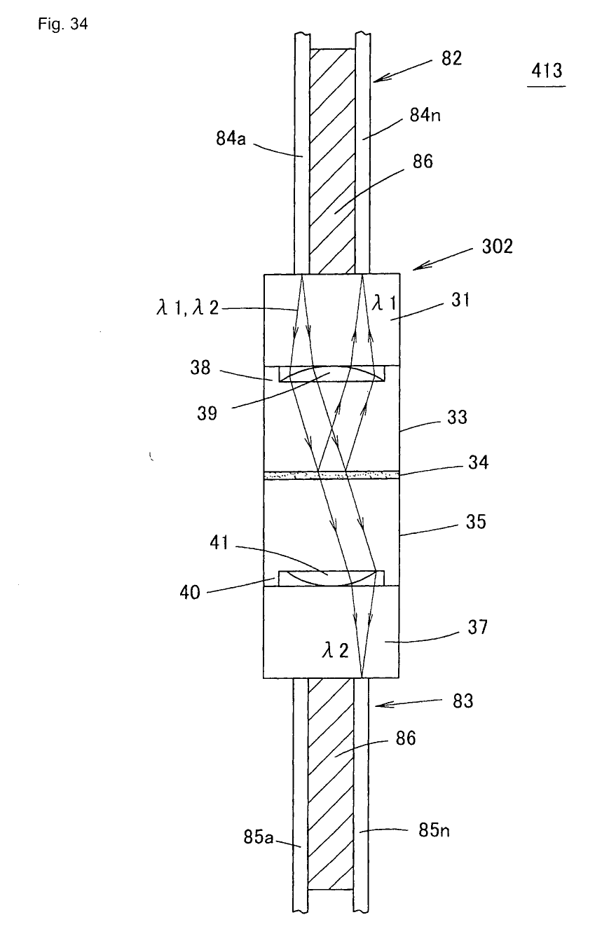

An optical multiplexing/demultiplexing module according to a tenth embodiment of the present invention will be described below. FIG. 33 is a perspective view showing an optical multiplexing/demultiplexing module 413 according to the tenth embodiment when viewed from below. FIG. 34 is a cross sectional view of the optical multiplexing/demultiplexing module 413. In the optical multiplexing/demultiplexing module 413, a fiber cable 82 including even numbers of optical fibers 84a, 84b, . . . and a fiber cable 83 including even numbers of optical fibers 85a, 85b, . . . are coupled to the upper surface and lower surface, respectively, of the optical multiplexer/demultiplexer 302 described in the first embodiment (modification). In the fiber cables 82 and 83, the even numbers of optical fibers 84a, 84b, . . . and the even numbers of optical fibers 85a, 85b, . . . are arrayed in an annular shape and fixed around cylindrical core materials 86 respectively. The fiber cables 82 and 83 are arranged such that the centers thereof are aligned with the central axes of the lenses 39 and 41.

In the optical multiplexing/demultiplexing module 413, when the light beams having the wavelengths λ1 and λ2 are inputted from one of the optical fibers, e.g., from the optical fiber 84a, the light beams transmitted through the lens 39 are converted into parallel light and incident on the filter 34. Among the light beams incident on filter 34, the light beam having the wavelength λ1 is reflected from the filter 34 and transmitted through the lens 39 again, and is coupled to one of the optical fibers which is located at the side opposite the optical fiber 84a in the fiber cable 82, e.g., to the optical fiber 84n. On the other hand, the light transmitted through the filter 34 is transmitted through the lens 41 and coupled to one of the optical fibers in the fiber cable 83 on the opposite side, e.g., to the optical fiber 85n.

In the optical multiplexing/demultiplexing module 413 having the above structure, the light beams having the wavelengths λ1 and λ2 may be inputted from one of the optical fibers in the plurality of optical fibers 84a, 84b, and the light beams having the wavelengths λ1 and λ2 may simultaneously be inputted from the plurality of optical fibers. Even when the light beams having the wavelengths λ1 and λ2 are inputted from the optical fibers 85a, 85b, . . . on the opposite side, the demultiplexing operation can also be performed. The multiplexing operation can also be performed.

Accordingly, in the present embodiment, many light beams having the wavelengths λ1 and λ2 can be demultiplexed by one pair of lenses, and the optical multiplexing/demultiplexing module 413 can be arrayed by one optical multiplexer/demultiplexer 302 having the one pair of lenses.

### Eleventh Embodiment

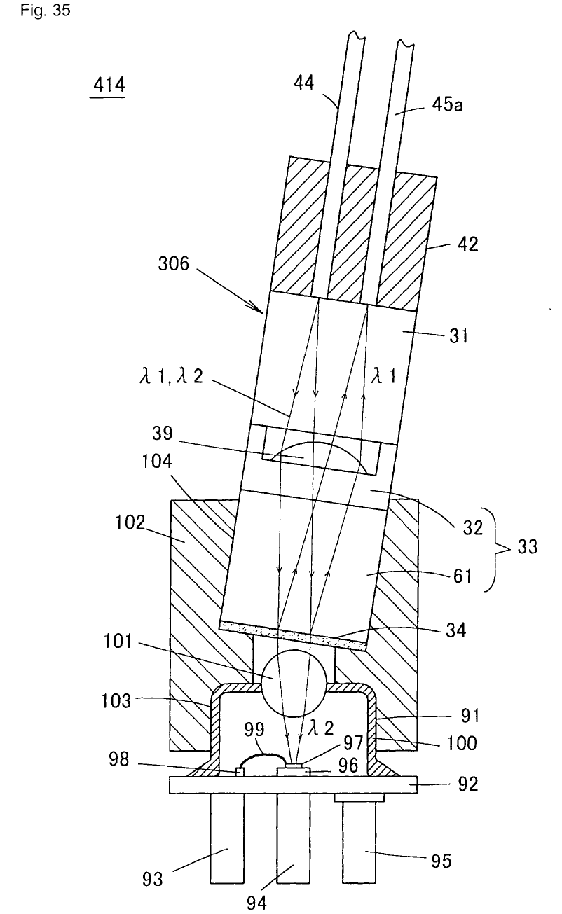

An optical multiplexing/demultiplexing module 414 according to an eleventh embodiment of the present invention will be described below. FIG. 35 is a cross sectional view showing an optical multiplexing/demultiplexing module 414 according to the eleventh embodiment. The optical multiplexer/demultiplexer 306 used in the optical multiplexing/demultiplexing module 414 has one lens as described in the fifth embodiment. The two-core fiber array 42 is coupled to the upper surface of the optical multiplexer/demultiplexer 306, and the lower portion of the optical multiplexer/demultiplexer 306 is connected to a can-type light sensitive portion 91 through a sleeve 102.

In the light sensitive portion 91, a light sensitive element 97 such as a photodiode is die-bonded to the upper surface of an electrode pad 96 provided on a metal base 92, and the light sensitive element 97 and a terminal pin 98 are connected through a bonding wire 99. The upper surface of the base 92 is covered with a metal cap 100, and a ball lens 101 is held in an opening provided in the central portion of the cap 100. Terminals 93, 94, and 95 which are electrically connected to the electrode pad 96, the terminal pin 98, and the like are provided on the lower surface of the base 92.

The light sensitive portion 91 is fixed in a positioned state in which the light sensitive portion 91 is perpendicularly fitted in a recess 103 provided in the lower portion of the sleeve 102, and the optical multiplexer/demultiplexer 306 is inserted and held in a holding portion 104 obliquely provided in the upper portion of the sleeve 102. The optical multiplexer/demultiplexer 305 is obliquely held such that the direction of the principal-axis light beam of the light beam having the wavelength λ2 outgoing from the lower surface is perpendicular to the light sensitive surface of the light sensitive element 97.

In the optical multiplexing/demultiplexing module 414, the light beams having the wavelengths λ1 and λ2 outgoing from the input optical fiber 44 are demultiplexed by the filter 34, and the light beam having the wavelength λ1 is coupled to the output optical fiber 45a. On the other hand, the light beam having the wavelength λ2 is transmitted through the filter 34 and outputted to the outside from the lower surface of the optical multiplexer/demultiplexer 306. Because the optical multiplexer/demultiplexer 306 is obliquely arranged such that the direction of the principal-axis light beam of the light beam having the wavelength λ2 is perpendicular to the light sensitive surface of the light sensitive element 97, the light beam having the wavelength λ2 outgoing through the filter 34 is perpendicularly incident on the center of the ball lens 101 and collected by the ball lens 101, and is efficiently received by the light sensitive element 97 arranged in the central portion of the light sensitive portion 91.

According to the embodiment, the optical multiplexer/demultiplexer 306 and the light sensitive portion 91 are integrally coupled through the sleeve 102, so that the size reduction can be achieved as a whole.

### Twelfth Embodiment

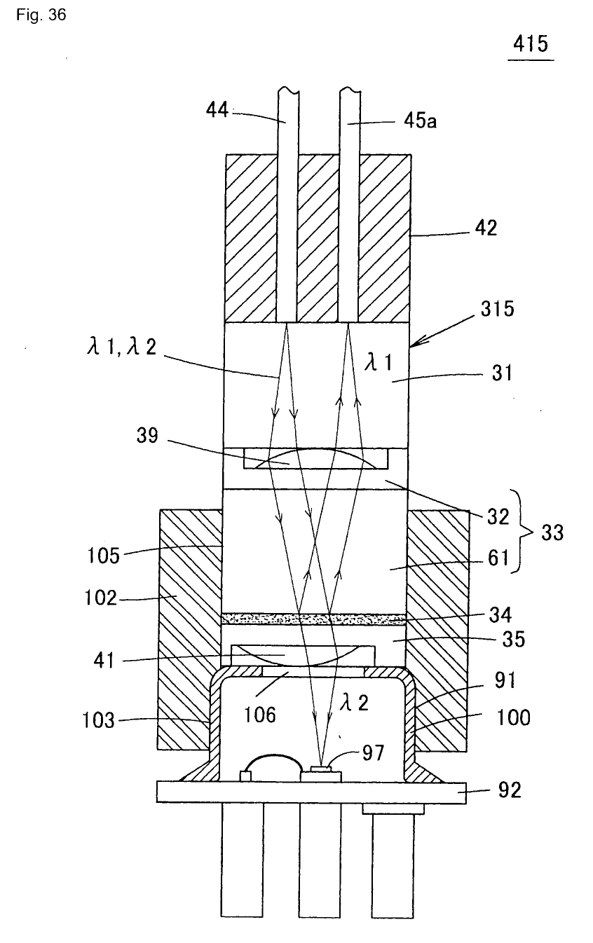

An optical multiplexing/demultiplexing module according to a twelfth embodiment of the present invention will be described below. FIG. 36 is a cross sectional view for explaining a structure of an optical multiplexing/demultiplexing module 415 according to the twelfth embodiment. In an optical multiplexer/demultiplexer 315 used in the optical multiplexing/demultiplexing module 415, the spacer 37 is removed from the optical multiplexer/demultiplexer 305 described in the fourth embodiment. The optical multiplexer/demultiplexer 315 has a structure similar to that of the fourth embodiment. The lens 41 is molded in the thin support plate 35, and is bonded to the filter 34 together with the support plate 35. However, the lens 41 is provided at a position which is shifted from the center of the optical multiplexer/demultiplexer 315, hence the central axis of the lens 41 is shifted from the central axis of the lens 39 provided at the center of the optical multiplexer/demultiplexer 314. The two-core fiber array 42 is coupled to the upper surface of the optical multiplexer/demultiplexer 315, and the lower portion of the optical multiplexer/demultiplexer 315 is perpendicularly connected to the light sensitive portion 91 using the sleeve 102.

The light sensitive portion 91 is perpendicularly inserted in the recess 103 in the lower portion of the sleeve 102, the optical multiplexer/demultiplexer 314 is inserted into a holding portion 105 perpendicularly provided in the upper portion of the sleeve 102, and the lower surface of the optical multiplexer/demultiplexer 302 abuts on the upper surface of the light sensitive portion 91. Consequently, dust hardly adheres to the lens 41 because the lens 41 is surrounded by the support plate 35, the light sensitive portion 91, and the sleeve 102. Although the assembly is performed such that the central axis of the optical multiplexer/demultiplexer 315 is aligned with the central axis of the light sensitive portion 91, the light sensitive element 97 is arranged at a position shifted from the center of the light sensitive portion 91.

In the optical multiplexing/demultiplexing module 415, the light beams having the wavelengths λ1 and λ2 outgoing from the input optical fiber 44 are demultiplexed by the filter 34, and the light beam having the wavelength λ1 is coupled to the output optical fiber 45a. On the other hand, the parallel light beam having the wavelength λ2 transmitted through the filter 34 is collected by the lens 41 and incident in the light sensitive portion 91. Furthermore, because the position of the lens 41 is shifted from the center of the optical multiplexer/demultiplexer 314, the light beam transmitted through the lens 41 is focused on the light sensitive element 97 located at the center of the light sensitive portion 91.

### Thirteenth Embodiment

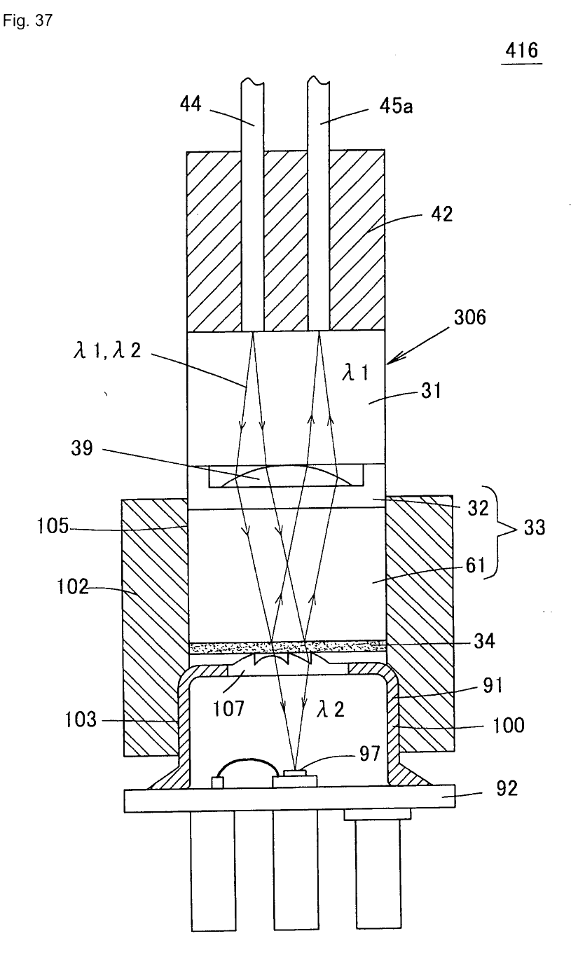

An optical multiplexing/demultiplexing module according to a thirteenth embodiment of the present invention will be described below. FIG. 37 is a cross sectional view for explaining a structure of an optical multiplexing/demultiplexing module 416 according to the thirteenth embodiment. The optical multiplexer/demultiplexer 306 used in the optical multiplexing/demultiplexing module 416 is already described in the fifth embodiment. The two-core fiber array 42 is coupled to the upper surface of the optical multiplexer/demultiplexer 306, and the lower portion of the optical multiplexer/demultiplexer 306 is perpendicularly connected to the light sensitive portion 91 using the sleeve 102. A Fresnel lens 107 is fitted in an opening window of the light sensitive portion 91, and the central axis of the Fresnel lens 107 is decentered from the center of the light sensitive portion 91. The light sensitive element 97 is arranged at a position shifted from the center of the light sensitive portion 91.

The light sensitive portion 91 is perpendicularly inserted into the recess 103 in the lower portion of the sleeve 102, the optical multiplexer/demultiplexer 306 is inserted into the holding portion 105 perpendicularly provided in the upper portion of the sleeve 102, and the upper surface in the recess 103 abuts on the upper surface of the light sensitive portion 91.

In the optical multiplexing/demultiplexing module 416, the light beams having the wavelengths λ1 and λ2 outgoing from the input optical fiber 44 are demultiplexed by the filter 34, and the light beam having the wavelength λ1 reflected from the filter 34 is coupled to the output optical fiber 45a. On the other hand, the parallel light beam having the wavelength λ2 transmitted through the filter 34 is outputted from the lower surface of the optical multiplexer/demultiplexer 306. In the present embodiment, the thin Fresnel lens 107 is used as the lens to bring the Fresnel lens 107 close to the filter 34 as much as possible, the direction of the principal axis light beam is bent by the Fresnel lens 107 before the light beam having the wavelength λ2 is largely shifted from the center of the optical multiplexer/demultiplexer 306, and the light beam having the wavelength λ2 is focused on the light sensitive element 97 provided at the center of the light sensitive portion 91.

### Fourteenth Embodiment

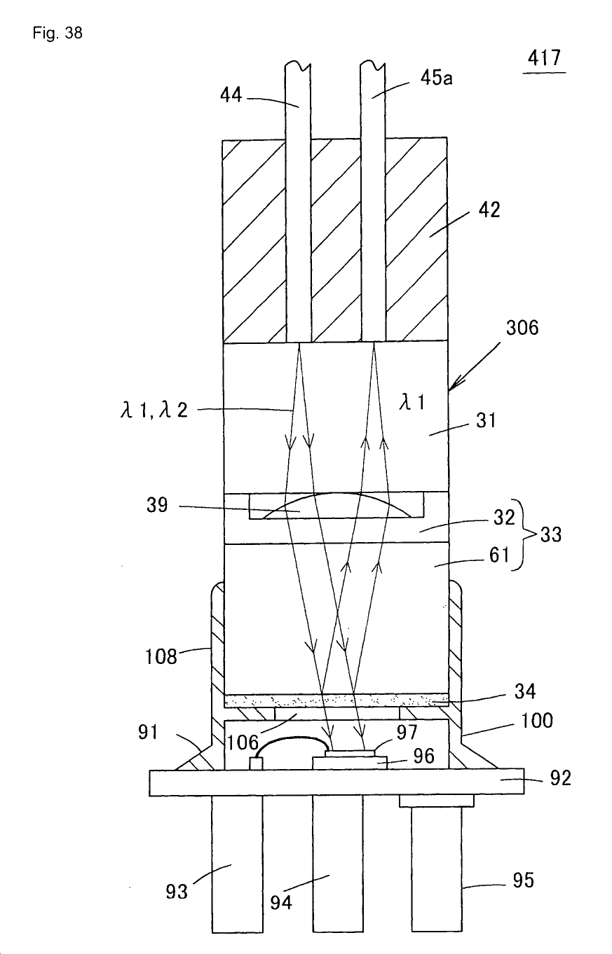

An optical multiplexing/demultiplexing module according to a fourteenth embodiment of the present invention will be described below. FIG. 38 is a cross sectional view for explaining a structure of an optical multiplexing/demultiplexing module 417 according to the fourteenth embodiment. The optical multiplexer/demultiplexer 306 used in the optical multiplexing/demultiplexing module 417 is already described in the fifth embodiment. The two-core fiber array 42 is coupled to the upper surface of the optical multiplexer/demultiplexer 306, and the lower portion of the optical multiplexer/demultiplexer 306 is connected to the light sensitive portion 91.

The light sensitive portion 91 is a dedicated product, and a cylindrical portion 108 is extended upward from the cap 100 in which an opening window 106 is provided. The lower portion of the optical multiplexer/demultiplexer 306 is perpendicularly inserted into and fixed in the cylindrical portion 108.

In the optical multiplexing/demultiplexing module 417, the light beams having the wavelengths λ1 and λ2 outgoing from the input optical fiber 44 are demultiplexed by the filter 34, and the light beam having the wavelength λ1 reflected from the filter 34 is collected by the lens 39 and coupled to the output optical fiber 45a. On the other hand, the parallel light beam having the wavelength λ2 transmitted through the filter 34 passes through the opening window 106 of the light sensitive portion 91 and enters the light sensitive portion 91, and then is received by the light sensitive element 97.

In the present embodiment, because the lens is not provided between the filter 34 and the light sensitive element 97, it is necessary that the parallel light obliquely outgoing from the filter 34 be received at the light sensitive element 97 before being largely shifted from the center. Accordingly, the distance between the filter 34 and the light sensitive element 97 is desirably short as much as possible, and the height of the cap 100 is preferably low. In order that the parallel light obliquely outgoing from the center of the filter 34 is received at the light sensitive element 97, it is desired that the area of the light sensitive element 97 is enlarged to a certain degree, and the light sensitive element 97 is arranged at a position shifted from the center of the light sensitive portion 91.

Alternatively, a method in which a light sensitive element having a larger light sensitive area is used or a method in which the optical multiplexer/demultiplexer 306 is connected while shifted from the central axis of the light sensitive portion 91 may be adopted in order to efficiently receive the light at the light sensitive element 97 arranged at the center of the light sensitive portion 91.

### Fifteenth Embodiment

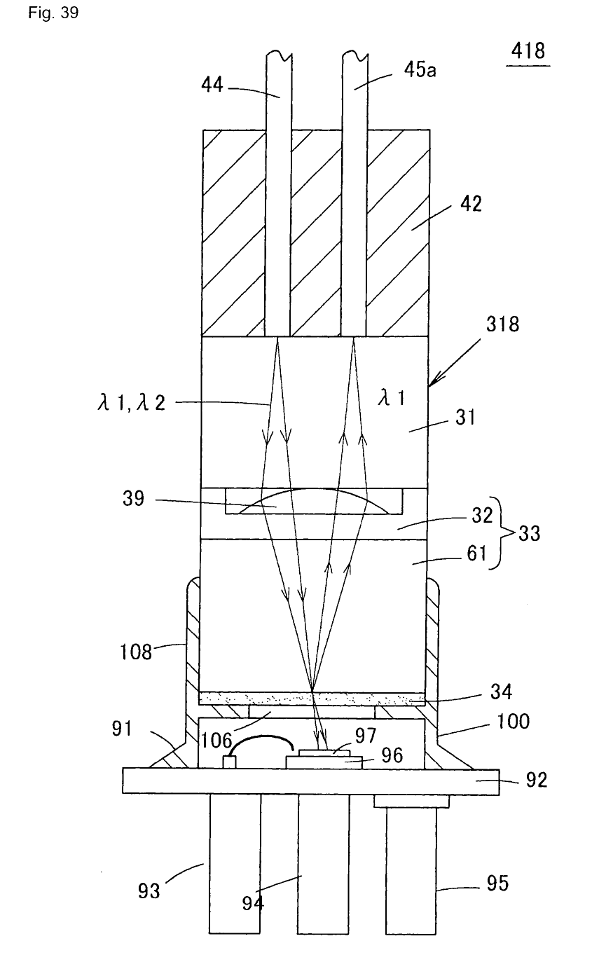

An optical multiplexing/demultiplexing module according to a fifteenth embodiment of the present invention will be described below. FIG. 39 is a cross sectional view for explaining a structure of an optical multiplexing/demultiplexing module 418 according to the fifteenth embodiment. An optical multiplexer/demultiplexer 318 used in the optical multiplexing/demultiplexing module 418 has a configuration similar to that of the optical multiplexer/demultiplexer 306 described in the fifth embodiment. However, in the optical multiplexer/demultiplexer 318, the thickness of the spacer 31 is larger than the focal distance of the lens 39, and the light beam outgoing from the input optical fiber 44 is focused on a position on the filter 34 after passing through the lens 39.

In the optical multiplexing/demultiplexing module 417, the light beams having the wavelengths λ1 and λ2 outgoing from the input optical fiber 44 are focused on a position on the filter 34 and demultiplexed by the filter 34. The light beam having the wavelength λ1 reflected from the filter 34 is incident on the lens 39 while diffused, and is collected by the lens 39 and coupled to the output optical fiber 45a.

On the other hand, because the distance between the filter 34 and the light sensitive element 97 is short, the light beam having the wavelength λ2 transmitted through the filter 34 enters the light sensitive portion 91 before spreading widely to be received by the light sensitive element 97. Therefore, even though a lens does not exist between the filter 34 and the light sensitive element 97, the light is efficiently received by the light sensitive element 97 arranged at the center of the light sensitive portion 91.

### Sixteenth Embodiment

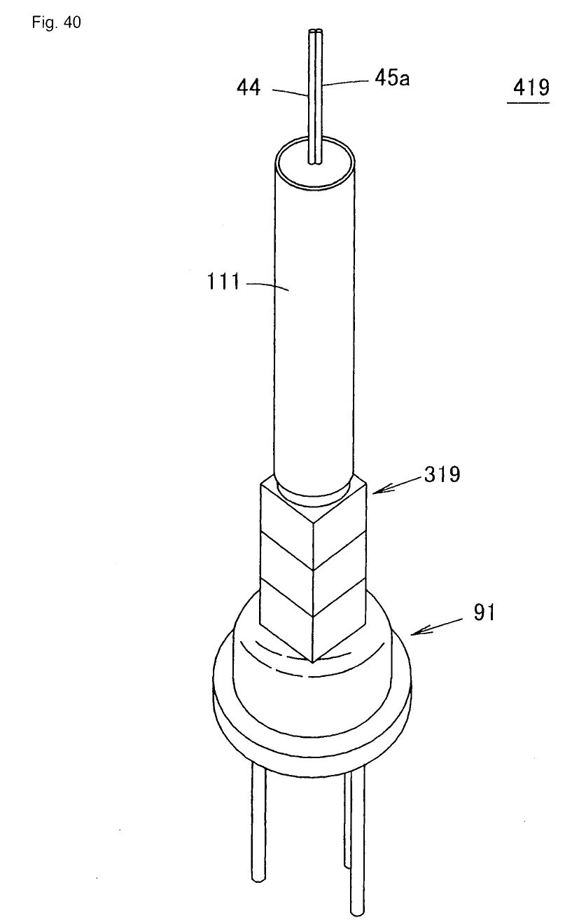

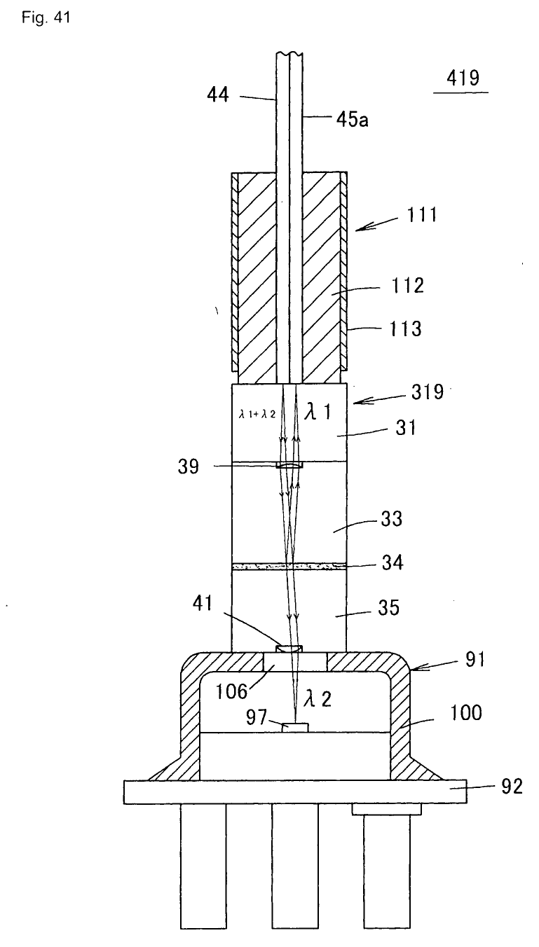

An optical multiplexing/demultiplexing module according to a sixteenth embodiment of the present invention will be described below. FIG. 40 is a cross sectional view for explaining a structure of an optical multiplexing/demultiplexing module 419 according to the sixteenth embodiment. FIG. 41 is a cross sectional view of the optical multiplexing/demultiplexing module 419. In the optical multiplexing/demultiplexing module 419, the downsizing is further achieved by directly bonding an optical multiplexer/demultiplexer 319 to the light sensitive portion 91. The optical multiplexer/demultiplexer 319 used here has a structure in which the spacer 37 is removed from the optical multiplexer/demultiplexer 302 shown in FIG. 12. The distance between the input optical fiber 44 and the output optical fiber 45a is shortened, and the lenses 39 and 41 are also miniaturized, whereby the downsizing of the optical multiplexer/demultiplexer 319 is achieved. Therefore, the optical multiplexer/demultiplexer 319 is formed in a smaller size compared with the light sensitive portion 91. In the optical multiplexer/demultiplexer 319, the lower surface is bonded to the upper surface of the opening of the light sensitive portion 91 using an adhesive agent while the central axis is slightly shifted from the central axis of the light sensitive portion 91. A two-core fiber cable 111 is coupled to the upper surface of the optical multiplexer/demultiplexer 319. In the fiber cable 111, the input optical fiber 44 and the output optical fiber 45a are covered with an inner layer 112 and an outer layer 113, a leading end face of the inner layer 112 exposed by peeling off a tip end portion of the outer layer 113 is bonded to the upper surface of the light sensitive portion 91.

According to the above structure, because the optical multiplexer/demultiplexer 319 is directly bonded to the light sensitive portion 91, the sleeve 102 and the like are not necessary, and the optical multiplexing/demultiplexing module 419 can greatly be miniaturized while the number of components is reduced. The downsizing can also be achieved by directly coupling the fiber cable 111 to the optical multiplexer/demultiplexer 319.

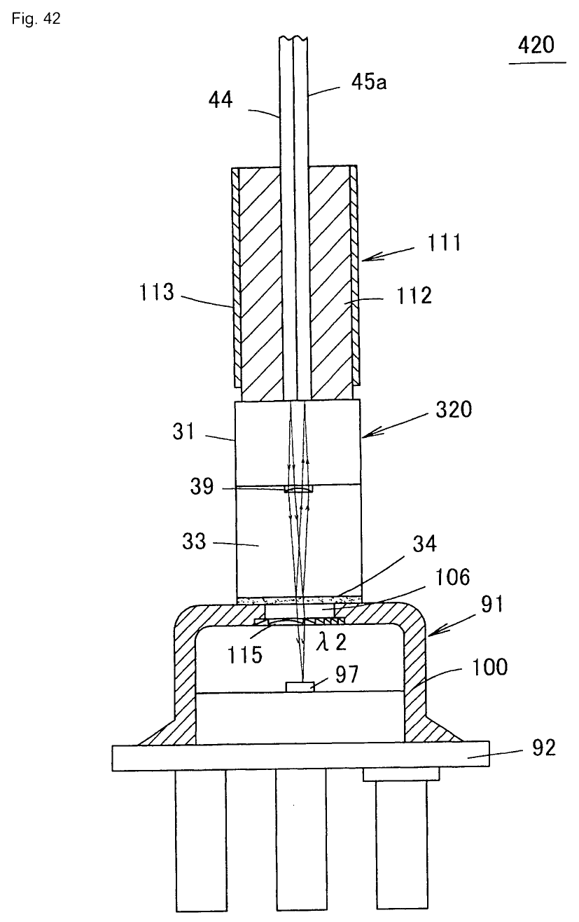

FIG. 42 is a cross sectional view showing a modification of the sixteenth embodiment. An optical multiplexer/demultiplexer 320 is used in an optical multiplexing/demultiplexing module 420. In the optical multiplexer/demultiplexer 320, the support plate 35 and the lens 41 are further removed from the optical multiplexer/demultiplexer 319 according to the sixteenth embodiment. A Fresnel lens 115 is provided instead in the opening window 106 of the light sensitive portion 91. According to the modification, because the optical multiplexer/demultiplexer 320 can further be miniaturized, the optical multiplexing/demultiplexing module 420 can be miniaturized.

Although the producing methods are described only for the first to third embodiments, the embodiments from the fourth embodiment can be produced by the methods similarly to those of the first to third embodiments. In the embodiments from the eleventh embodiment, the optical multiplexer/demultiplexer is coupled to the light sensitive portion. However, instead of the light sensitive portion, the optical multiplexer/demultiplexer can also be connected to a light emitting portion.

1. An optical multiplexer/demultiplexer characterized in that
a filter portion is provided in one of surfaces of a transparent support plate,
a lens is integrally molded in a surface of the support plate opposite the filter portion, and
a transparent spacer is bonded to the support plate with the lens sandwiched between the transparent spacer and the support plate.

2. The optical multiplexer/demultiplexer according to claim 1, wherein a lens different from the lens is provided in an outer surface of the filter portion.

3. An optical multiplexer/demultiplexer characterized in that a filter portion is sandwiched between a pair of transparent support plates, lenses are integrally molded in surfaces of the support plates opposite the filter portion respectively, and a transparent spacer is bonded to each of the support plates with the lens sandwiched between the transparent spacer and the support plate.

4. The optical multiplexer/demultiplexer according to claim 1, wherein a projection which is projected higher than a thickness of the lens is provided in the support plate.

5. The optical multiplexer/demultiplexer according to claim 4, wherein the projection is formed around the lens so as to surround the lens, and the lens is sealed in a space surrounded by the support plate, the projection, and the spacer.

6. The optical multiplexer/demultiplexer according to claim 2, wherein the respective lenses have the same shape.

7. The optical multiplexer/demultiplexer according to claim 6, wherein central axes of the respective lenses are shifted from each other.

8. The optical multiplexer/demultiplexer according to claim 1, wherein a plurality of lenses are provided in a surface substantially parallel to the filter portion according to the filter portion.

9. The optical multiplexer/demultiplexer according to claim 3, wherein the filter portion has two filters arranged at right angles to each other,
a light beam having a first wavelength range among incident light beams having three wavelength ranges is reflected from one of the filters and taken out to the outside,
the light beam having the second wavelength range among the light beams having the second and third wavelength ranges transmitted through the one of the filters is transmitted through the other filter and taken out to the outside, and
the light beam having the third wavelength range is reflected from the other filter and taken out to the outside.

10. The optical multiplexer/demultiplexer according to claim 3, wherein the filter portion has two filters arranged in parallel with each other and a light reflecting surface,
a light beam having a first wavelength range among incident light beams having three wavelength ranges is reflected from one of the filters and taken out to the outside,
the light beam having the second wavelength range among the light beams having the second and third wavelength ranges transmitted through the one of the filters is transmitted through the other filter and taken out to the outside, and
the light beam having the third wavelength range is reflected from the other filter and the light reflecting surface and taken out to the outside from the same side as the light beam having the second wavelength range.

11. An optical multiplexing/demultiplexing module characterized in that one of end portions of the optical multiplexer/demultiplexer according to claim 1 is coupled to a light emitting portion or a light sensitive portion, and a fiber array including a plurality of optical fibers is coupled to the other end face of the optical multiplexer/demultiplexer.

12. An optical multiplexing/demultiplexing module characterized in that, using the optical multiplexer/demultiplexer according to claim 1 in which parallel light beam is outputted from an end face on a filter side, an end portion on the filter side of the optical multiplexer/demultiplexer is attached to a light sensitive portion while inclined, the light sensitive portion including a lens in an opening thereof.

13. An optical multiplexing/demultiplexing module characterized in that an end portion on a filter side of the optical multiplexer/demultiplexer according to claim 1 is attached to a light sensitive portion, a light beam inputted to the filter is collected in the vicinity of the filter, and the light beam is received in the light sensitive portion before the light beam widely spreads.

14. An optical multiplexing/demultiplexing module characterized in that one of end portions of the optical multiplexer/demultiplexer according to claim 2 is attached to a light emitting portion or a light sensitive portion with a central axis of the optical multiplexer/demultiplexer shifted from the center of the light emitting portion or the light sensitive portion.

15. An optical multiplexing/demultiplexing module characterized in that fiber arrays are coupled to both end faces of the optical multiplexer/demultiplexer according to claim 3, the fiber array including a plurality of optical fibers.

16. (canceled)

17. A method of producing the optical multiplexer/demultiplexer according to claim 1, characterized by:
providing the filter portion in one of surfaces of a first wafer which constitutes the support plate;
molding the plurality of lenses in the other surface of the first wafer;
bonding a second wafer which constitutes the spacer to the first wafer such that the whole of the lens is sandwiched between the first wafer and the second wafer; and cutting the laminated body to produce the individual optical multiplexer/demultiplexer by dicing, the plurality of lenses being sandwiched between the first and second wafers in the laminated body.

18. A method of producing the optical multiplexer/demultiplexer according to claim 3, characterized by:
providing the filter portion in one of surfaces of a first wafer which constitutes the support plate;
molding the plurality of lenses in the other surface of the first wafer;
bonding a second wafer which constitutes the spacer onto the first wafer with the lens located between the first and second wafers;
bonding another first wafer which constitutes the support plate to the first wafer with the filter portion located between the another first wafer and the first wafer;
molding another plurality of lenses in an exposed surface of the another first wafer;
laminating another second wafer which constitutes the spacer to another first wafer with the another lens located between the another second wafer and the another first wafer, and forming a laminated body; and
cutting the laminated body to produce the individual optical multiplexer/demultiplexer by dicing.

19. A method of producing the optical multiplexer/demultiplexer according to claim 3, characterized by:
providing the filter portion in one of surfaces of a first wafer which constitutes the support plate;
molding the plurality of lenses in the other surface of the first wafer;
bonding a second wafer which constitutes the spacer to the first wafer such that the whole of the lens is sandwiched between the first wafer and the second wafer;
producing an interim component by dicing the laminated body in which the plurality of lenses are sandwiched between the first and second wafers; and
producing the individual optical multiplexer/demultiplexer by bonding the surfaces in which the filter portion of the interim component is provided.

20. The optical multiplexer/demultiplexer producing method according to claim 17, wherein the lens is molded by a molding process in which an ultraviolet curing resin is used.

21. The optical multiplexer/demultiplexer producing method according to claim 17, wherein, when the second wafer is bonded to the first wafer, a projection which is higher than a thickness of the lens is formed in a surface of the first wafer, and the second wafer is bonded to the projection.

22. The optical multiplexer/demultiplexer producing method according to claim 21, wherein an adhesive agent is supplied between the projection and the second wafer by utilizing capillarity when the second wafer is bonded to the first wafer in which the lens is molded.

23. The optical multiplexer/demultiplexer producing method according to claim 22, wherein a groove for supplying the adhesive agent is formed in a portion adjacent to the projection of the first wafer, the adhesive agent bonding the first wafer to the second wafer.

24. The optical multiplexer/demultiplexer according to claim 3, wherein a projection which is projected higher than a thickness of the lens is provided in the support plate.

25. The optical multiplexer/demultiplexer according to claim 3, wherein the respective lenses have the same shape.

26. The optical multiplexer/demultiplexer according to claim 3, wherein a plurality of lenses are provided in a surface substantially parallel to the filter portion according to the filter portion.

27. An optical multiplexing/demultiplexing module characterized in that one of end portions of the optical multiplexer/demultiplexer according to claim 3 is coupled to a light emitting portion or a light sensitive portion, and a fiber array including a plurality of optical fibers is coupled to the other end face of the optical multiplexer/demultiplexer.

28. An optical multiplexing/demultiplexing module characterized in that one of end portions of the optical multiplexer/demultiplexer according to claim 3 is attached to a light emitting portion or a light sensitive portion with a central axis of the optical multiplexer/demultiplexer shifted from the center of the light emitting portion or the light sensitive portion.
